(19) United States
(12) Patent Application Publication
(10) Pub. No.: US 2014/0078219 A1
(43) Pub. Date: Mar. 20, 2014

(54) PIEZOELECTRIC MOTOR, ROBOT HAND, ROBOT, ELECTRONIC COMPONENT TRANSPORTING APPARATUS, ELECTRONIC COMPONENT INSPECTING APPARATUS, LIQUID FEEDING PUMP, PRINTING APPARATUS, ELECTRONIC TIMEPIECE, PROJECTING APPARATUS, AND TRANSPORTING APPARATUS

(71) Applicant: Seiko Epson Corporation, Tokyo (JP)

(72) Inventor: Yoshiteru NISHIMURA, Shiojiri (JP)

(73) Assignee: Seiko Epson Corporation, Tokyo (JP)

(21) Appl. No.: 14/029,070

(22) Filed: Sep. 17, 2013

(30) Foreign Application Priority Data
Sep. 18, 2012 (JP) 2012-204043
Sep. 18, 2012 (JP) 2012-204044

(51) Int. Cl. H02N 2/04; F04B 43/09; B25J 18/02; B41J 19/20; B25J 15/08

(52) U.S. Cl. CPC H02N 2/04; B41J 19/202; B25J 15/08; B25J 18/02; F04B 43/095
USPC 347/37; 310/323.02; 294/213; 74/490.03; 294/86.4; 417/413.2

(57) ABSTRACT

A vibration case includes a first side portion and a second side portion provided on the both sides of a vibrator in a bending direction and a coupling portion configured to couple the first side portion and the second side portion. In this configuration, stiffness of the vibrator in the bending direction is increased, and the deformation of the vibration case may be suppressed. This structure contributes to reduction in size of the vibration case as long as the same stiffness is secured, and hence the size of the vibration case may be reduced while securing high stiffness. Therefore, a piezoelectric motor having a driving accuracy secured sufficiently may be realized while suppressing increase in size of the piezoelectric motor.

### BACKGROUND

1. Technical Field

The present invention relates to a piezoelectric motor, a robot hand, a robot, an electronic component carrier apparatus, an electronic component inspecting apparatus, a liquid feeding pump, a printing apparatus, an electronic timepiece, a projecting apparatus, and a carrier apparatus.

2. Related Art

A piezoelectric motor of a system which generates a stretching vibration and a bending vibration simultaneously by applying a drive voltage on a vibrator formed so as to include a piezoelectric material and friction-drives an object by a projection formed on an end surface of the vibrator is known (JP-A-2008-187768). The piezoelectric motor drives the object by vibrating the vibrator at small amplitude and a high frequency, and hence has advantages that the object may be positioned at a high resolution performance and, in addition, the object may be driven rapidly.

Since the piezoelectric motor of this system drives the object with a frictional force with respect to the depression, the projection needs to be pressed against the object when used. In order to obtain a large drive force, the projection needs to be pressed against the object with a large force and, in order to do so, the vibrator is preferably held firmly. In contrast, in view of a driving principle, the vibrator needs to be held so that the vibration thereof is not interrupted.

Therefore, a method of providing the piezoelectric motor having a double case structure by storing the vibrator in a vibration case and storing the vibration case in an outer case, and pressing the vibrator (and the projection of the vibrator) against the object together with the vibration case by a spring provided between the vibration case and the outer case is proposed (JP-A-2009-33788). In this method, the vibration case (and the vibrator) is firmly held by the outer case so that the vibration case moves only in the direction toward the object by allowing the vibration case to slide with respect to the outer case, and the vibrator may be held by the vibration case so as not to interrupt the vibration of the vibrator.

However, in the piezoelectric motor of a type in which the vibration case having the vibrator integrated therein is accommodated in the outer case, what kind of structure the vibration case needs to have is not known. In other words, when stiffness of the vibration case is not sufficient, the vibration case may be deflected due to the vibration of the vibrator or a reaction force generated when the object is driven and hence the driving accuracy of the object is lowered, or a sliding movement with respect to the outer case may be interfered and hence the projection of the vibrator cannot be pressed against the object. On the other hand, if the stiffness of the vibration case is simply increased, the size of the vibration case is increased, and the large vibration case needs to be accommodated in the outer case, so that the size of the piezoelectric motor is more and more increased. In addition, cable routing also needs to be considered for applying the drive voltage on the vibrator, and sacrificing the stiffness of the vibration case for the cable routing is not preferable. In this manner, a structure of the vibration case significantly affects the size of the piezoelectric motor, the driving accuracy, and the cable routing to the vibrator, and there is a problem that the structure of the vibration case from these points of view is not considered yet.

### SUMMARY

An advantage of some aspects of the invention is to provide an piezoelectric motor having a vibration case ensuring the driving accuracy while suppressing increase in size of the piezoelectric motor and allowing easy cable routing.

An aspect of the invention is directed to a piezoelectric motor including: a vibrator including a piezoelectric material, and configured to vibrate in a stretching direction and a bending direction by an application of a voltage; and a vibration case in which the vibrator is accommodated, the vibration case includes: a first side portion provided in the bending direction with respect to the vibrator; a second side portion provided on the side opposite to the first side portion with the vibrator interposed therebetween; and a coupling portion provided in a direction orthogonal to the bending direction and the stretching direction with respect to the vibrator, and configured to couple the first side portion and the second side portion.

In the piezoelectric motor according to the aspect of the invention, the vibration case configured to accommodate the vibrator includes the first side portion and the second side portion provided on the both sides of the vibrator in the bending direction and the coupling portion configured to couple the first side portion and the second side portion. A structure in which the first side portion and the second side portion provided on the both sides in the bending direction are coupled with the coupling portion as described above is known to generate a large cross-sectional secondary moment in the bending direction. Therefore, in the vibration case of this configuration, stiffness of the vibrator in the bending direction can be increased, and hence the deformation of the vibration case can be suppressed. According to the teaching of the material mechanics, as described later in detail, the structure in which the first side portion and the second side portion are coupled with the coupling portion have little portion that contributes only a little to the stiffness. Therefore, if the same stiffness is to be secured, the size of the vibration case can be reduced. In addition, the vibrator can be accommodated in a portion surrounded by a plane of the first side portion, a plane of the second side portion, and a plane of the coupling portion. In this manner, the structure of the vibration case provided in the piezoelectric motor of as aspect of the invention is a structure which allows reduction in size of the vibration case while securing high stiffness. Therefore, the piezoelectric motor having a driving accuracy secured sufficiently can be realized while suppressing increase in size of the piezoelectric motor.

The piezoelectric motor according to the aspect of the invention may be configured such that the length of the first side portion in the stretching direction, the length of the second side portion in the stretching direction, and the length of the coupling portion in the stretching direction are formed to be longer than the length of the vibrator in the stretching direction.

With this configuration, since the entire part of the vibrator can be accommodated in the vibration case, an event that something interferes with the vibrator and the vibrator gets damaged can be avoided.

The piezoelectric motor according to the aspect of the invention may be configured such that the first side portion, the second side portion, and the coupling portion each have a plate-like portion, and the thickness of the plate-like portion that the coupling portion has is thinner than the thickness of the plate-like portion that the first side portion has and the thickness of the plate-like portion that the second side portion has.

According to the teaching of the material mechanics, even when the thickness of the coupling portion is reduced in comparison with the thicknesses of the first side portion and the second side portion, the stiffness hardly lowers. Therefore, in the configuration described above, the vibration case can be reduced in size with little lowering of the stiffness.

The piezoelectric motor according to the aspect of the invention may be configured such that the plane of the coupling portion facing the vibrator is formed with a projection configured to support the vibrator at a position corresponding to a node of vibration in the bending direction. Here, the expression “position corresponding to a node of vibration” indicates a position overlapped with the node of vibration in the bending direction when viewing in the direction of thickness of the vibrator (the direction orthogonal to the bending direction and the stretching direction of the vibrator).

With this configuration, since the projection of the coupling portion comes into contact with the vibrator, heat generated when the vibrator vibrates can be released in the vibration case via the projection. Therefore, a change of features, lowering of performance of the piezoelectric motor, or shortening of the lifetime due to increase in temperature of the vibrator can be avoided. Since the projection is provided at a portion of the node of vibration, interruption of the vibration of the vibrator can be suppressed. In addition, since generation of large friction at a contact portion between the projection and the vibrator can be suppressed, a probability of generation of abrasion or frictional heat and hence heat released from the vibrator can be suppressed.

The piezoelectric motor according to the aspect of the invention may be configured as follows. First, the depression is formed on the flat surface of the coupling portion facing the vibrator at a position corresponding to the node of vibration in the bending direction. Then, a shock-absorbing member is provided in the depression to support the vibrator therewith.

With this configuration, since the shock-absorbing member configured to support the vibrator is formed in the depression, displacement of the position of the shock-absorbing member by a force generated when the vibrator vibrates can be suppressed.

The piezoelectric motor according to the aspect of the invention may be configured as follows. The coupling portion is provided with the shock-absorbing member on the side facing the vibrator, at the position corresponding to a node of vibration in the bending direction to support the vibrator by the shock-absorbing member. A portion of the flat surface of the coupling portion where at least the shock-absorbing member is provided is formed into a concavo-convex shape.

With this configuration, since the shock-absorbing member configured to support the vibrator digs into the concavo-convex shape, displacement of the position of the shock-absorbing member by the force generated when the vibrator vibrates can be suppressed.

Another aspect of the invention is directed to a piezoelectric motor including: a vibrator including a piezoelectric material and configured to vibrate in a stretching direction and a bending direction by an application of a voltage; and a vibration case in which the vibrator is accommodated, the vibration case includes: a first side portion provided in the bending direction with respect to the vibrator; a second side portion provided on the side opposite to the first side portion with the vibrator interposed therebetween; and a coupling portion provided in a direction orthogonal to the bending direction and the stretching direction with respect to the vibrator and configured to couple the first side portion and the second side portion, wherein the first side portion or the second side portion is provided with a through hole.

In the piezoelectric motor according to the aspect of the invention, the vibration case configured to accommodate the vibrator includes the first side portion and the second side portion provided on both sides of the vibrator in the bending direction and the coupling portion configured to couple the first side portion and the second side portion. A structure in which the first side portion and the second side portion provided on the both sides in the bending direction are coupled with the coupling portion as described above is known to generate a large cross-sectional secondary moment in the bending direction. Therefore, in the vibration case of this configuration, stiffness of the vibrator in the bending direction can be increased, and hence the deformation of the vibration case can be suppressed. According to the teaching of the material mechanics, as described later in detail, the structure in which the first side portion and the second side portion are coupled with the coupling portion have little portion that contributes only a little to the stiffness. Therefore, the size of the vibration case can be reduced for securing the same stiffness. In addition, the vibrator can be accommodated in a portion surrounded by the first side portion, the second side portion, and the coupling portion. Furthermore, since the configuration is only such that the through hole is formed in the first side portion or the second side portion, little lowering of the stiffness of the vibration case occurs. Also, the portion surrounded by the first side portion, the second side portion and the coupling portion can accommodate the vibrator. Besides, since the first and second side portion are provided with a through hole, the vibrator can be provided with the cable routing through the through hole. In addition, since the first side portion or the second side portion is simply provided with the through hole, there is little lowering of the stiffness of the vibration case. Therefore, the piezoelectric motor having a driving accuracy secured and allowing cable routing can be realized while suppressing increase in size of the piezoelectric motor.

The piezoelectric motor according to the aspect of the invention may be configured such that the through hole is provided at a position corresponding to the node of vibration when the vibrator vibrates in the bending direction. Here, the expression “position corresponding to a node of vibration” indicates the position overlapped with the node of vibration in the bending direction when viewing in the direction of thickness of the vibrator (the direction orthogonal to the bending direction and the stretching direction of the vibrator).

With this configuration, the cable routing can be provided at a center of the vibrator in the longitudinal direction where the node of vibration exists so as to minimize the influence on the vibration of the vibrator.

The piezoelectric motor according to the aspect of the invention may be configured such that the through hole is provided obliquely with respect to the bending direction of the vibrator.

There may be a case where the routed cable needs to be drawn out obliquely due to layout restrictions and the like when mounting the piezoelectric motor. In such a case, by forming the through hole so as to be inclined with respect to the bending direction of the vibrator, the routed cable can be drawn out in the direction toward the through hole without being forcedly bent.

The piezoelectric motor according to the aspect of the invention may be configured such that the first side portion or the second side portion provided with the through hole is composed of a plurality of members, and the through hole is provided between the plurality of members.

With this configuration, for example, a configuration in which the members are formed with grooves and the through hole is formed by combining these members is also possible. Therefore, flexibility when forming the through hole and flexibility relating to the shape of the through hole can also be improved.

The piezoelectric motor according to the aspect of the invention may be configured such that the coupling portion is provided with a depression on the side facing the vibrator at a position corresponding to the through hole. Here, the expression “position corresponding to the through hole” indicates a position overlapping with the through hole with respect to the stretching direction of the vibrator.

With this configuration, when routing the cable from the outside of the vibration case to the vibrator, the cable passed through the through hole can be routed to the depression and guiding from the depression to the vibrator. Therefore, even though a space between the vibrator and the coupling portion is narrow, cable routing is easily achieved.

The piezoelectric motor according to the aspect of the invention may be configured such that a chamfered portion or a curved surface portion is provided at an angular portion of a position where the through hole is formed.

When the piezoelectric motor drives an object, or when an apparatus having the piezoelectric motor mounted thereon is operated, the routed cable can be vibrated. In such a case as well, damage of the cable by grazing against the angular portion can be avoided by providing the first side portion or the second portion with the chamfered portion or the curved surface portion at the angular portion of a position where the through hole is formed.

The invention may be grasped as the following form. That is, still another aspect of the invention is directed to a robot hand including a plurality of finger portions and configured to grip an object, including a base body on which the finger portions are provided upright so as to be movable; and the piezoelectric motor described above configured to move the finger portions with respect to the base body.

In the robot hand having such a configuration, since the stiffness of the vibration case in the bending direction of the vibrator can be increased, deformation of the vibration case can be suppressed. If the same stiffness is to be secured, the size of the vibration case can be reduced. Therefore, since the piezoelectric motor having the driving accuracy secured can be realized while suppressing increase in size of the piezoelectric motor, a high-performance robot hand can be realized.

The invention may be grasped as a robot of the following configuration. That is, yet another aspect of the invention is directed to a robot including: an arm portion provided with a rotatable joint portion; a hand portion provided with the arm portion, and a main body portion provided with the arm portion, and the piezoelectric motor described above provided on the joint portion and configured to bend or rotate the joint portion.

In this configuration, since the piezoelectric motor being compact and having a high driving accuracy is mounted, a high-performance robot being compact and having a high positional accuracy can be realized.

The invention may be grasped as the following form. That is, still yet another aspect of the invention is directed to an electronic component transporting apparatus including: a grip portion configured to grip an electronic component; and the piezoelectric motor described above configured to drive the grip portion gripping the electronic component.

In this configuration, since the piezoelectric motor being compact and having a high driving accuracy is mounted, an electric component transporting apparatus being compact, having a high positional accuracy, and having a high transporting accuracy can be realized.

The invention may be grasped as the following form. That is, further another aspect of the invention is directed to an electronic component inspecting apparatus including: a grip portion configured to grip an electronic component; the piezoelectric motor described above configured to drive the grip portion gripping the electronic component; and an inspection unit configured to inspect the electronic component.

In this configuration, since the piezoelectric motor being compact and having a high driving accuracy is mounted, an electric component inspecting apparatus being compact, having a high positional accuracy, and having a high transporting accuracy can be realized.

The invention may be grasped as the following form. That is, Still further another aspect of the invention is directed to a liquid feeding pump including: a liquid tube in which liquid can flow; a closing portion configured to close the liquid tube by coming into abutment with part of the liquid tube; a moving portion configured to move the closed portion of the liquid tube by moving in the state of holding the closing portion; and the piezoelectric motor described above configured to move the moving portion.

In this configuration, since the piezoelectric motor being compact and having a high driving accuracy is mounted, a liquid feeding pump being compact and having a high liquid-feeding accuracy can be realized.

The invention may be grasped as the following form. That is, yet further another aspect of the invention is directed to a printing apparatus including: a print head configured to print an image on a medium; and the piezoelectric motor described above configured to move the print head.

In this configuration, since the piezoelectric motor being compact and having a high driving accuracy is mounted, a printing apparatus being compact and having a high image quality can be realized.

The invention may be grasped as the following form. That is, still yet further aspect of the invention is directed to an electronic timepiece including: a rotatable rotating disk provided with teeth coaxially; a gear train including a plurality of gears; a hand connected to the gear train to indicate time of day; and the piezoelectric motor described above configured to drive the rotating disk.

In this configuration, since the piezoelectric motor being compact and having a high driving accuracy is mounted, an electric timepiece being compact and having a high time-counting accuracy can be realized.

The invention may be grasped as the following form. That is, a further aspect of the invention is directed to a projecting apparatus including: a projecting portion including an optical lens and configured to project light from a light source; an adjusting portion configured to adjust a projecting state of the light by the optical lens; and the piezoelectric motor described above configured to drive the adjusting portion.

In this configuration, since the piezoelectric motor being compact and having a high driving accuracy is mounted, a projecting apparatus being compact and being capable of adjusting the projecting state of the light by the optical lens with high degree of accuracy can be realized.

The invention may be grasped as the following form. That is, a still further aspect of the invention is directed to a transporting apparatus configured to transport an object including: a grip portion configured to grip an object; and the piezoelectric motor described above configured to drive the grip portion gripping the object.

In this configuration, since the piezoelectric motor being compact and having a high driving accuracy is mounted, a transporting apparatus being compact and having a high transporting accuracy can be realized.

### BRIEF DESCRIPTION OF THE DRAWINGS

The invention will be described with reference to the accompanying drawings, wherein like numbers reference like elements.

FIGS. 1A and 1B are explanatory drawings illustrating a rough configuration of a piezoelectric motor of a first embodiment.

FIG. 2 is an exploded view illustrating a structure of a body portion of the first embodiment.

FIGS. 3A to 3C are explanatory drawings illustrating operation principles of the piezoelectric motor.

FIGS. 4A and 4B are explanatory drawings illustrating a structure of a vibration case of the first embodiment.

FIGS. 5A to 5D are explanatory drawings showing the reason why stiffness of the vibration case of the first embodiment is high.

FIGS. 6A to 6C are schematic drawings illustrating a vibration case of a first modification of the first embodiment.

FIGS. 7A and 7B are schematic drawings illustrating a vibration case of a second modification of the first embodiment.

FIG. 8 is a schematic drawing illustrating a vibration case of a third modification of the first embodiment.

FIGS. 9A and 9B are explanatory drawings illustrating a rough configuration of a piezoelectric motor of a second embodiment.

FIG. 10 is an exploded assembling drawing illustrating the structure of the body portion of the second embodiment.

FIGS. 11A and 11B are explanatory drawings illustrating a structure of a vibration case of the second embodiment.

FIG. 12 is an explanatory drawing illustrating a state in which a power cable is drawn out sideward of the piezoelectric motor of the second embodiment.

FIGS. 13A and 13B are explanatory drawings showing the reason why the power cable may be drawn out to the side of the piezoelectric motor without impairing the stiffness of the vibration case of the second embodiment.

FIGS. 14A to 14C are explanatory drawings illustrating a vibration case of a modification in which a second side portion is composed of a plurality of members combined each other.

FIG. 15 is an explanatory drawing illustrating the vibration case of the modification in which a depression for cable is provided at a coupling portion.

FIG. 16 is an explanatory drawing illustrating the vibration case of the modification in which a through hole is formed obliquely with respect to the second side portion.

FIGS. 17A and 17B are explanatory drawings illustrating through holes of the modifications in which the through holes are formed with chamfered portions and curved surface portions, respectively at angular portions at positions where the openings are formed.

FIG. 18 is an explanatory drawing illustrating a robot hand in which the piezoelectric motor of the first embodiment or the second embodiment is assembled.

FIG. 19 is an explanatory drawing illustrating a single arm robot having the robot hand.

FIG. 20 is an explanatory drawing illustrating a multi-arm robot having the robot hand.

FIG. 21 is a perspective view illustrating an electronic component inspecting apparatus in which the piezoelectric motor of the first embodiment or the second embodiment is assembled.

FIG. 22 is an explanatory drawing illustrating a fine-adjustment mechanism integrated in a gripping device.

FIGS. 23A and 23B are explanatory drawings illustrating a liquid feeding pump in which the piezoelectric motor of the first embodiment or the second embodiment is assembled.

FIG. 24 is a perspective view illustrating a printing apparatus in which the piezoelectric motor of the first embodiment or the second embodiment is assembled.

FIG. 25 is an explanatory drawing illustrating an electronic timepiece in which the piezoelectric motor of the first embodiment or the second embodiment is assembled.

FIG. 26 is a perspective view illustrating a projecting apparatus in which the piezoelectric motor of the first embodiment or the second embodiment is assembled.

### DESCRIPTION OF EXEMPLARY EMBODIMENTS

### First Embodiment

### A. Configuration of Apparatus

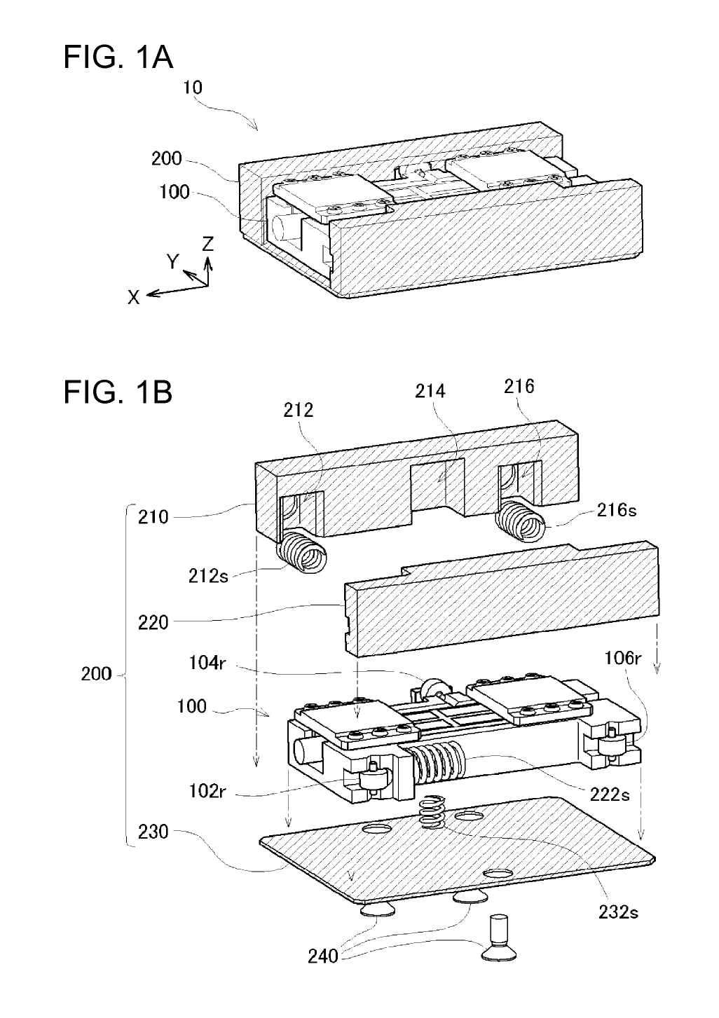

FIGS. 1A and 1B are explanatory drawings illustrating a rough configuration of a piezoelectric motor 10 of a first embodiment. FIG. 1A illustrates a general view of the piezoelectric motor 10 of the first embodiment, and FIG. 1B illustrates an exploded view. As illustrated in FIG. 1A, the piezoelectric motor 10 of the first embodiment roughly includes a body portion 100 and an outer case 200. The body portion 100 is mounted inside the outer case 200, and in this state, is movable in one direction. In this specification, the direction of movement of the body portion 100 is referred to as “X direction”. As illustrated in the drawings, directions orthogonal to the X direction are referred to as “Y direction” and “Z direction”, respectively.

The body portion 100 and the outer case 200 are each composed of a plurality of components combined each other. For example, the outer case 200 is composed of a first side wall block 210 and a second side wall block 220 fastened with setscrews 240 on the both sides of an upper surface of a substantially rectangular shaped substrate 230 (see FIG. 1B). When assembling the piezoelectric motor 10, the first side wall block 210 and the second side wall block 220 are mounted on the substrate 230 from above the body portion 100 by using the setscrews 240.

The first side wall block 210 is formed with three depressions including a front housing 212, a center housing 214, and a rear housing 216. The first side wall block 210 is mounted on the substrate 230 in a state in which a front side compression spring 212s is stored in the front housing 212 and a rear side compression spring 216s is stored in the rear housing 216. Consequently, the body portion 100 is brought into a state of being pressed against the second side wall block 220 by the front side compression spring 212s and the rear side compression spring 216s. A front roller 102r and a rear roller 106r are mounted on a side surface of the body portion 100 facing the second side wall block 220. A pressure buildup spring 222s is provided on the side surface of the body portion 100. The pressure buildup spring 222s presses the body portion 100 in the X direction at a position on the rear side of the front roller 102r.

A holding roller 104r is provided on a side surface of the body portion 100 on the side opposite to the side where the front roller 102r and the rear roller 106r are provided so as to face in the Z direction (upward in the drawing). In a state in which the first side wall block 210 is mounted, the holding roller 104r is stored in the center housing 214 of the first side wall block 210. A holding spring 232s is provided between the back side of a portion of the body portion 100 where the holding roller 104r is provided and the substrate 230. Therefore, the holding roller 104r is in a state of being pressed against an inner surface of the center housing 214 in the Z direction (upward in the drawing).

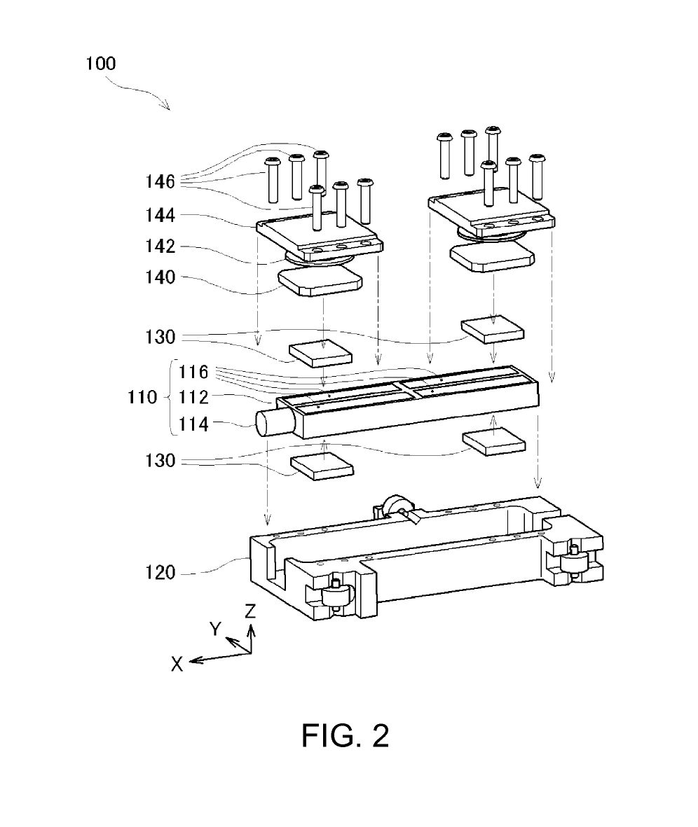

FIG. 2 is an exploded assembling drawing illustrating a structure of the body portion 100 of the first embodiment. The body portion 100 roughly has the structure in which a vibrating unit 110 is stored in a vibration case 120. The vibrating unit 110 includes a vibrator 112 formed of a piezoelectric material into a parallelepiped shape, a driving projection 114 formed of ceramic and mounted on an end surface of the vibrator 112 in the longitudinal direction (X direction), and four front electrodes 116 provided respectively on quartering parts on one side of the vibrator 112. Although not illustrated in FIG. 2, a back electrode which covers almost the entire part of the surface is provided on a side opposite to the side on which the four front electrodes 116 are provided, and the back electrode is grounded.

The vibrating unit 110 is stored in the vibration case 120 in a state of being interposed between shock-absorbing members 130 formed of a material having a dynamic viscous resiliency (ex. polyimide resin, rubber, elastomer) from the both surfaces where the front electrodes 116 and the back electrode are provided (both surfaces in the Z direction in FIG. 2). Then, plate-like holding plates 140, resilient members 142, and holding lids 144 formed of a metallic material are placed from above the shock-absorbing members 130 on the side of the front electrodes 116, and the holding lids 144 are fastened to the vibration case 120 with setscrews 146. Therefore, the vibrating unit 110 is stored in a state in which the vibrator 112 may vibrate in the vibration case 120 by a shear deformation of the resin-made shock-absorbing members 130 in spite of being held down by resilient forces of the resilient members 142. In the first embodiment, disc springs are used as the resilient members 142. The direction in which the shock-absorbing members 130 interpose the vibrator 112 from the both sides (Z direction) corresponds to a direction intersecting the direction of bending vibrations of the vibrator 112 (bending direction) as described later.

### B. Operation Principles of Piezoelectric Motor

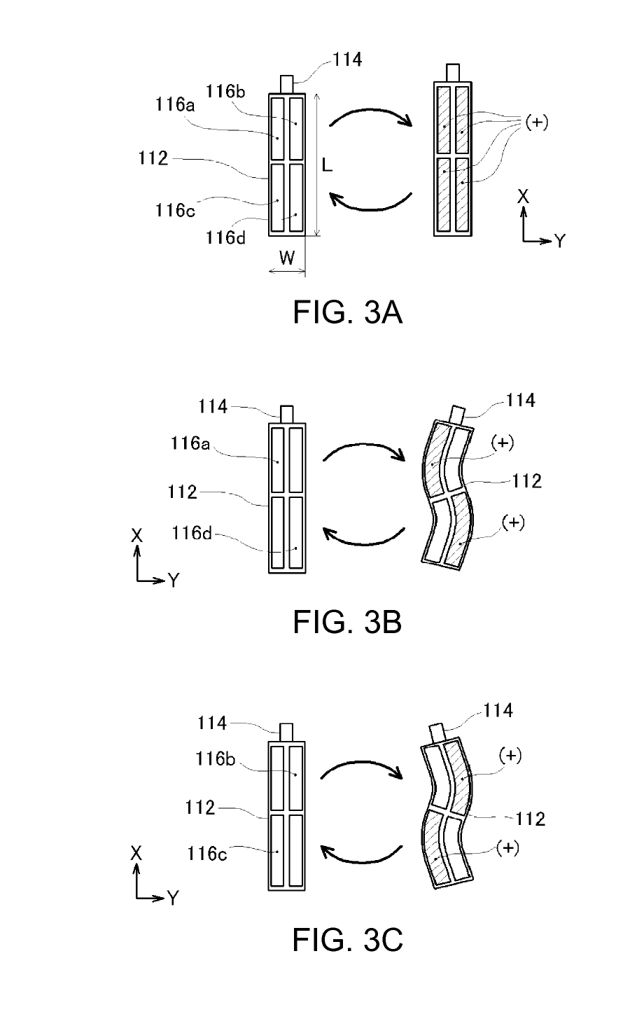

FIGS. 3A to 3C are explanatory drawings illustrating operation principles of the piezoelectric motor 10. The piezoelectric motor 10 is operated by an elliptic motion of the driving projection 114 of the vibrating unit 110 when a voltage is applied to the front electrodes 116 of the vibrating unit 110 at a constant cycle. The reason why the driving projection 114 of the vibrating unit 110 makes the elliptic motion will be described below.

First of all, a piezoelectric material has a property to expand when a positive voltage is applied as publicly known. Therefore, as illustrated in FIG. 3A, when an action to apply the positive voltage to all of the four front electrodes 116 and then release the applied voltage is repeated, the vibrator 112 formed of the piezoelectric material repeats an action of expanding and contracting in the longitudinal direction (X direction). In this manner, the action of the vibrator 112 repeating the expansion and the contraction in the longitudinal direction (X direction) is referred to as “stretching vibration”. When the frequency of the positive voltage to be applied is gradually changed, the amount of expansion and contraction is suddenly increased when a specific frequency is reached, and a kind of resonance phenomenon occurs. The frequency at which the resonance occurs in the stretching vibration (resonance frequency) is determined by a physical property of the vibrator 112, the dimensions (a width W, a length L, and a thickness T) of the vibrator 112.

As illustrated in FIG. 3B or FIG. 3C, two of the front electrodes 116 at diagonal positions are paired (a pair of a front electrode 116a and a front electrode 116d, or a pair of a front electrode 116b and a front electrode 116c), and a positive voltage is applied at a constant cycle. Then, the vibrator 112 repeats an action of shaking a distal end portion (a portion where the driving projection 114 is mounted) in the longitudinal direction (X direction) rightward or leftward in the drawing. For example, as illustrated in FIG. 3B, when a positive voltage is applied to the pair of the front electrode 116a and the front electrode 116d at a constant cycle, the vibrator 112 repeats the action shaking the distal end portion rightward in the drawing. Also, as illustrated in FIG. 3C, when a positive voltage is applied to the pair of the front electrode 116b and the front electrode 116c at a constant cycle, the vibrator 112 repeats the action shaking the distal end portion leftward in the drawing. Such an action of the vibrator 112 is referred to as “bending vibration”. As regards such a bending vibration, there exists a resonance frequency determined by the physical property of the vibrator 112 and the dimensions (the width W, the length L, and the thickness T) of the vibrator 112. Therefore, when a positive voltage is applied at that resonance frequency on the two front electrodes 116 at the diagonal positions, the vibrator 112 vibrates by shaking the distal end portion rightward or leftward (Y direction) significantly. In the description given below, the direction of the stretching vibration (X direction) may be referred to as “stretching direction”, and the direction of the bending vibration (Y direction) may be referred to as “bending direction”. The direction orthogonal to both of the stretching direction and the bending direction (Z direction) may be referred to as “thickness direction” of the vibrator 112.

Here, the resonance frequency of the stretching vibration illustrated in FIG. 3A and the resonance frequency of the bending vibration illustrated in FIG. 3B or 3C are also determined by the physical property of the vibrator 112 or the dimensions (the width W, the length L, and the thickness T) of the vibrator 112. Therefore, by selecting the dimensions (the width W, the length L, and the thickness T) of the vibrator 112 adequately, the resonance frequency may be matched. When a voltage of a mode of the bending vibration as illustrated in FIG. 3B or FIG. 3C is applied on the vibrator 112 at the resonance frequency, the bending vibration occurs as illustrated in FIG. 3B or FIG. 3C, and simultaneously, the stretching vibration illustrated in FIG. 3A is also induced by resonance. Consequently, when the voltage is applied in the mode illustrated in FIG. 3B, the distal end portion (the portion where the driving projection 114 is mounted) of the vibrator 112 starts a clockwise elliptical motion in the drawing. Also, when the voltage is applied in the mode illustrated in FIG. 3C, the distal end portion of the vibrator 112 starts a counterclockwise elliptical motion in the drawing.

The piezoelectric motor 10 drives the object by using the above-described elliptical motion. In other words, the elliptical motion is generated in a state of pushing the driving projection 114 of the vibrator 112 against the object. Then, the driving projection 114 repeats an action of moving from the left to the right (or from the right to the left) in a state of being pressed against the object when the vibrator 112 expands, and then restoring to an original position in a state of being separated from the object when the vibrator 112 direction by a frictional force received from the driving projection 114. Since the drive force that the object receives is equal to the frictional force generated with respect to the driving projection 114, the magnitude of the drive force is determined by a coefficient of friction between the driving projection 114 and the object, and a force by which the driving projection 114 is pressed against the object.

As is apparent from the operation principle of the piezoelectric motor 10 described above, the piezoelectric motor 10 vibrates the vibrator 112 in the stretching direction (X direction) and the bending direction (Y direction) in a state in which the driving projection 114 is pressed against the object when being used. Therefore, the vibrator 112 needs to be accommodated in the vibration case 120 in a state in which the vibrations in the stretching direction and the bending direction are allowed. When moving the object by vibrating the vibrator 112, a reaction force from the object is applied to the driving projection 114. When the vibrator 112 moves within the vibration case 120 by this reaction force, a sufficient driving force cannot be transmitted to the object, and hence the amount of movement of the driving projection 114 is decreased. Consequently, the amount of driving of the object is also reduced. In addition, since an amount of relief of the body portion 100 is not necessarily stable, and hence the driven amount of the object is also unstable.

Also, as described above, in the structure in which the vibrator 112 is accommodated in the vibration case 120, the reaction force generated by driving the object is transmitted to the vibration case 120 via the driving projection 114 and the vibrator 112. Since the vibration case 120 is assembled to the outer case 200 in a mode movable in the stretching direction (X direction), if the vibration case 120 is deformed by the reaction force from the object, the movement in the stretching direction in the outer case 200 is interfered. Consequently, the driving projection 114 of the vibrator 112 cannot be pushed against the object. Also, when the vibration case 120 is deformed, the position of the vibration case 120 is displaced in the outer case 200. Therefore, the position of the driving projection 114 is also displaced, and hence the driving accuracy of the object is also lowered. Furthermore, since the vibrator 112 is held by the vibration case 120 via the shock-absorbing members 130, the reaction force generated by the bending vibration (and the stretching vibration) of the vibrator 112 also acts in the direction to deform the vibration case 120. From these reasons, the vibration case 120 needs to have sufficient stiffness at least in the bending direction of the vibrator 112. On the other hand, if stiffness of the vibration case 120 is simply increased, the size of the vibration case 120 is increased, and the vibration case 120 needs to be accommodated in the outer case 200, so that the size of the piezoelectric motor is increased. Therefore, in the vibration case 120 of the piezoelectric motor 10 of the first embodiment, the following configuration is employed.

### C. Structure of Vibration Case

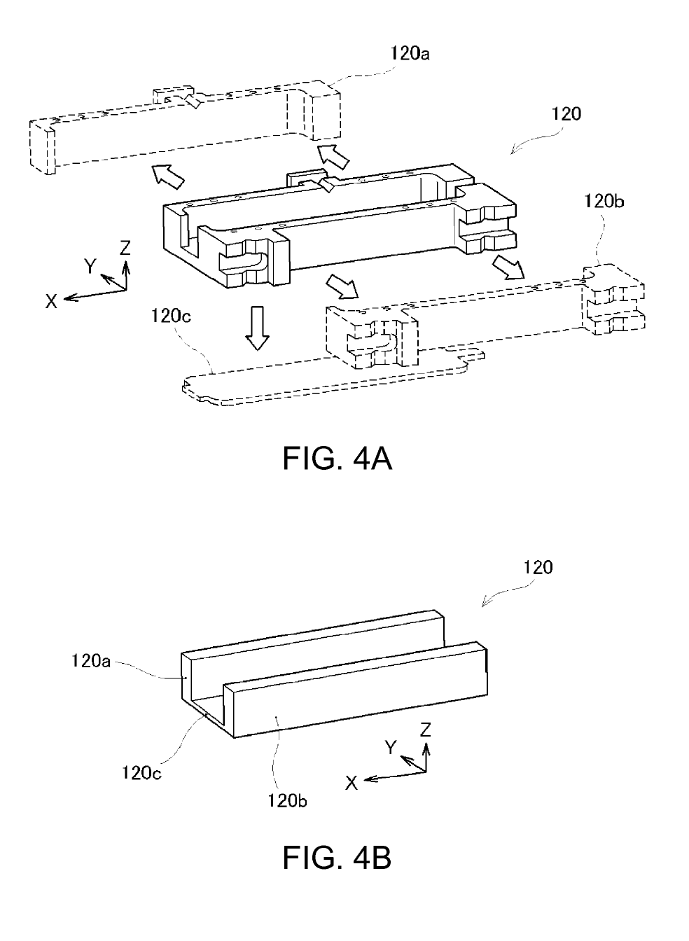

FIGS. 4A and 4B are explanatory drawings illustrating a structure of the vibration case 120 in terms of stiffness in the bending direction of the vibrator 112. In terms of the stiffness in the bending direction, the vibration case 120 of the first embodiment may be considered to have a structure in which a first side portion 120a provided in the bending direction (Y direction) with respect to the vibrator 112 (see FIG. 2) and a second side portion 120b provided on the side opposite to the first side portion 120a with the vibrator 112 interposed therebetween are coupled by a coupling portion 120c provided in the Z direction with respect to the vibrator 112 as illustrated in FIG. 4A.

The first side portion 120a and the second side portion 120b do not have a simple flat shape, but is provided with a structure for mounting the front roller 102r, the rear roller 106r, or the holding roller 104r (see FIG. 1B) (see FIG. 1B as regards the front roller 102r, the rear roller 106r, and the holding roller 104r). However, such a structure does not contribute to the stiffness in terms of the stiffness in the bending direction. Therefore, the structure of the vibration case 120 of the first embodiment may be simplified as illustrated in FIG. 4B. The structure illustrated in FIG. 4B is a structure having high stiffness in the bending direction.

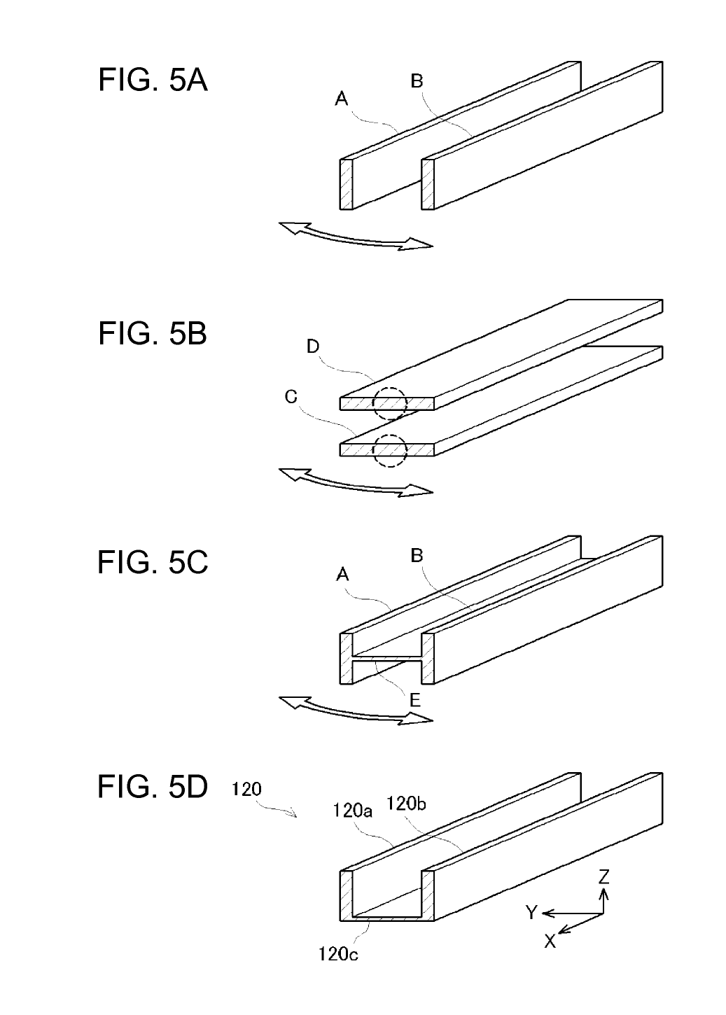

FIGS. 5A to 5D are explanatory drawings illustrating the reason why the stiffness of the vibration case 120 of the first embodiment is high. For example, as illustrated in FIG. 5A, a structure in which two plate-like members A and B are arranged in parallel is considered. This structure may be considered to be a weak structure (low stiffness in the direction indicated by an arrow) for a load in the direction indicated by a hollow arrow in the drawing because the individual members are easily bent even though the respective members A and B share the load applied thereto. Therefore, a configuration in which the individual members are arranged in the direction which resists being bent by the load applied in the direction indicated by the arrow is now considered.

FIG. 5B illustrates a structure in which two plate-like members C and D are arranged in the direction which resists being bent by the load indicated by a hollow arrow. This structure may be said to be a structure having high stiffness in the direction indicated by an arrow in comparison with the structure illustrated in FIG. 5A since the respective members can hardly be bent. According to the teaching of the material mechanics, the structure in FIG. 5B may be said to be a wasteful structure because portions which contribute little to the stiffness (portions surrounded by broken lines in the drawing) are generated in the members C and D.

In contrast, a structure in FIG. 5C in which the two plate-like members A and B illustrated in FIG. 5A are coupled via a separate plate-like member E is considered. In this structure, since the two members A and B are coupled, the individual members A and B do not bend separately. For example, when the member A makes an attempt to be bent by the load indicated by a hollow arrow in the drawing, a tensile force or a compression force is generated in the member B. Therefore, the member A does not bend unless the load is increased extraordinarily. The same applies to the member B, and when the member B makes an attempt to bend, a tensile force or a compression force is generated in the member A. Therefore, the member B does not bend unless the load is increased extraordinarily. As a result, the structure illustrated in FIG. 5C may be said to be a structure which resists being bent by the load indicated by an arrow in the drawing (having high stiffness). In addition, since the member E is only for coupling the two members A and B and hence does not receive the load positively, the thickness of the member E may be smaller than that of the members A and B. Therefore, like portions surrounded by the broken lines in FIG. 5B, stiffness higher than the structure in FIG. 5B may be realized with little likelihood of generating portions which do not contribute to the stiffness.

The structure in FIG. 5C is the same as the structure of the vibration case 120 of the first embodiment described with reference to FIG. 4B above. For the sake of convenience of understanding, the same drawing as FIG. 4B is illustrated again as FIG. 5D.

As is apparent when comparing FIG. 5C and FIG. 5D, the first side portion 120a of the vibration case 120 corresponds to the member A in FIG. 5C, the second side portion 120b of the vibration case 120 corresponds to the member B in FIG. 5C, and the coupling portion 120c of the vibration case 120 corresponds to the member E in FIG. 5C. Furthermore, the direction of the load indicated by the arrow in FIG. 5C corresponds to the Y direction (bending direction) of the vibration case 120. Therefore, the vibration case 120 illustrated in FIG. 5D may be said to be a structure having high stiffness with respect to the Y direction (bending direction).

In addition, most part of the cross-section of the vibration case 120 in FIG. 5D taken along a YZ plane in the same drawing contributes to the stiffness. Therefore, if the same stiffness is to be realized, the structure illustrated in FIG. 5D may contribute to reduce the size of the vibration case 120. In addition, the vibrator 112 may be accommodated in a portion surrounded by the first side portion 120a, the second side portion 120b, and the coupling portion 120c. As a result, the structure of the vibration case 120 of the first embodiment has high stiffness in the bending direction of the vibrator 112 and, in addition, may contribute to reducing the size of the vibration case 120.

As described above, the vibration case 120 of the first embodiment has a structure in which the first side portion 120a and the second side portion 120b are provided on the both sides of the vibrator 112 in the bending direction and the first side portion 120a and the second side portion 120b are coupled with the coupling portion 120c from the viewpoints of securing the stiffness in the bending direction and reducing the size of the vibration case 120. Therefore, as having been employed in a piezoelectric motor of the related art, the vibrator 112 may hardly be held with a resin member or the like from the both sides in the bending direction. Therefore, in the vibration case 120 of the first embodiment, an innovative method such as holding the both sides of the vibrator 112 by interposing with the shock-absorbing members 130 from the thickness direction (Z direction) is employed as illustrated in FIG. 2. In other words, the structure of the vibration case 120 of the first embodiment may be said to be a peculiar structure in that development of the innovative method of holding the vibrator 112 by interposing the same from the thickness direction (Z direction) is required.

### D. Modifications

The piezoelectric motor 10 of the first embodiment described above has various modifications. These modifications will be described briefly below. In the following modifications, portions different from the piezoelectric motor 10 of the first embodiment will be focused for description and description of the same configuration as the piezoelectric motor 10 of the above-described first embodiment will be omitted by assigning the same reference numerals.

### D-1. First Modification

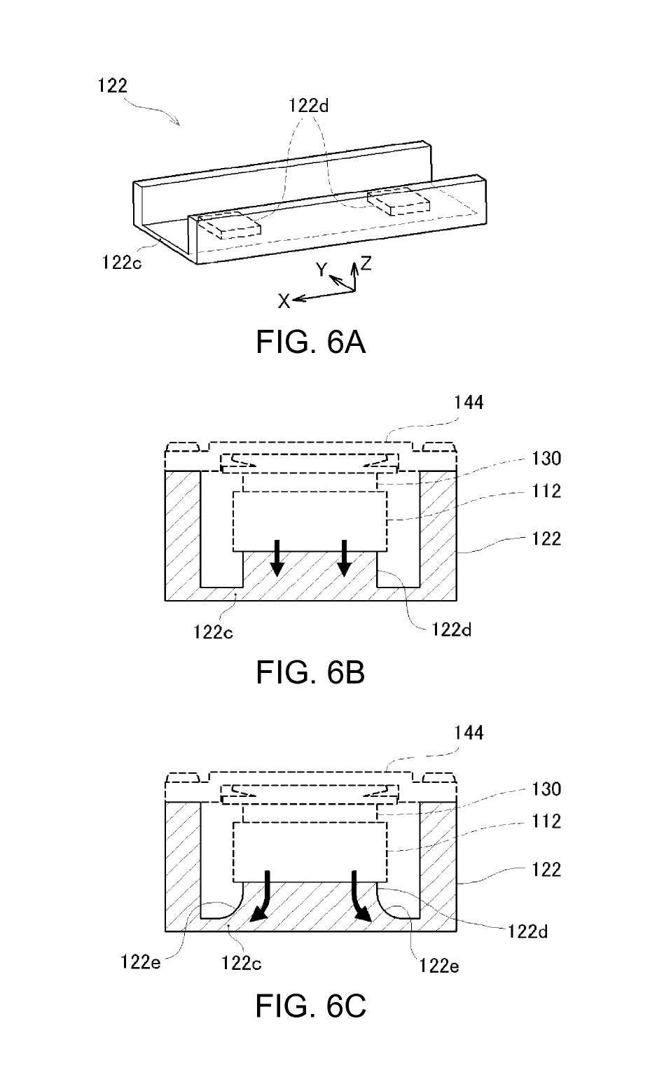

In the first embodiment described above, the vibrator 112 is held via the shock-absorbing members 130. However, the holding configuration is not limited thereto. For example, as conceptually illustrated in FIG. 6A, the vibrator 112 may be supported by projections 122d projecting from a coupling portion 122c of a vibration case 122.

FIG. 6B illustrates a cross-sectional view of the vibration case 122 of a first modification taken along an YZ plane. In the drawing, the vibrator 112 assembled into the vibration case 122, the shock-absorbing member 130, and the holding lid 144 are also illustrated by broken lines. As illustrated, according to the first modification, the projection 122d projecting from the vibration case 122 is in contact with the vibrator 112.

As publicly known, when an AC voltage is applied to the vibrator 112 for vibration, the vibrator 112 generates heat. Consequently, if the temperature of the vibrator 112 is extraordinarily increased, the function as the piezoelectric motor 10 is lowered. From this point of view, since the vibration case 122 of the first modification is in contact with the vibrator 112 by the projections 122d, the heat generated in the vibrator 112 may be released to the vibration case 122 via the projections 122d. Arrows illustrated in FIG. 6B conceptually indicate the flow of heat from the vibrator 112.

In addition, the projections 122d are provided at positions corresponding to nodes of the bending vibration when the vibrator 112 performs the bending vibration. Therefore, even through the vibrator 112 vibrates, a significant friction may be suppressed from occurring at portions of contact between the projections 122d and the vibrator 112. Consequently, spaces are generated between the vibrator 112 and the projections 122d, and the heat transmission from the vibrator 112 to the projections 122d is not interfered and, in addition, heat generation by the friction at the contact portions may also be suppressed. Therefore, degradation of performance of the vibrator 112 due to the temperature increase may further be suppressed.

In FIG. 6B, root portions of the projections 122d projecting from the coupling portion 122c of the vibration case 122 have been described as being formed so as to intersect the surface of the coupling portion 122c at substantially right angle. However, as illustrated in FIG. 6C, portions where the root portions of the projections 122d intersect the surface of the coupling portion 122c may be formed into an R-shape. In this configuration, as illustrated by arrows in the drawing, heat dispersion from the vibrator 112 to the vibration case 122 may further be accelerated. In addition, a stress concentration may be suppressed from occurring at the root portions 122e of the projections 122d, display of cracks in the root portions 122e of the projections 122d may be avoided.

### D-2. Second Modification

In the first embodiment described above, as illustrated in FIG. 4A, the coupling portion 120c of the vibration case 120 has been described as being formed to have a flat surface on the side facing the vibrator 112. Then, in the description, the shock-absorbing members 130, the vibrator 112, and the shock-absorbing members 130 are stacked on this flat surface in this order to hold the vibrator 112 (see FIG. 2). However, the vibrator 112 may be held by providing depressions in the coupling portion 120c of the vibration case 120 and stacking the vibrator 112 and the shock-absorbing members 130 in this order on the shock-absorbing members 130 provided in this depression.

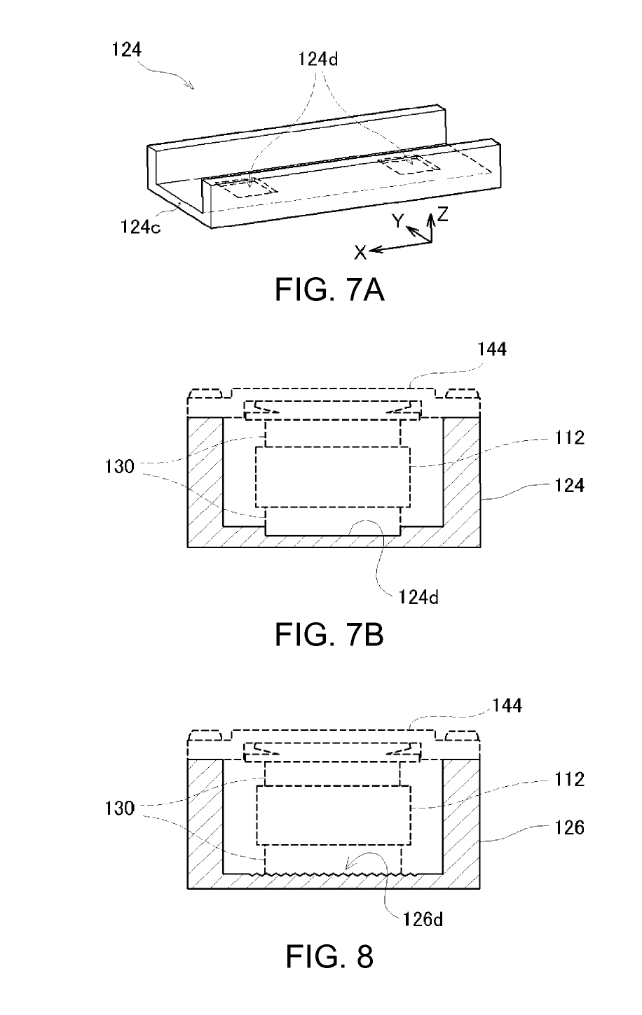

FIG. 7A conceptually illustrates a vibration case 124 of a second modification configured as described above. As illustrated, depressions 124d are formed in a coupling portion 124c of the vibration case 124 at two positions corresponding to the nodes of the bending vibration of the vibrator 112. FIG. 7B also illustrates a cross-sectional view of the vibration case 124 of the second modification taken along an YZ plane. In the drawing, the vibrator 112 assembled into the vibration case 122, the shock-absorbing members 130, and the holding lid 144 are also illustrated by broken lines.

As illustrated in FIG. 7B, in the second modification, the vibrator 112 is held by fitting the shock-absorbing members 130 in the depressions 124d provided in the vibration case 124, and stacking the vibrator 112 and the shock-absorbing members 130 thereon in this order. In this configuration, the shock-absorbing members 130 fitted in the depressions 124d may be suppressed from being displaced by a force received from the vibrator 112 when the vibrator 112 vibrates.

### D-3. Third Modification

It is also possible to provide a non-skid rough surface portion for the shock-absorbing members 130 instead of fitting the shock-absorbing members 130 in the depressions 124d provided in the coupling portion 124c of the vibration case 124. FIG. 8 illustrates a cross-sectional shape of a vibration case 126 of a third modification as described above. As illustrated, in the vibration case 126 of the third modification, a non-skid rough surface portion 126d is formed on the surface of the coupling portion 126c for the shock-absorbing members 130. Although the rough surface portion 126d needs only to be formed at positions where the shock-absorbing members 130 are placed. However, it is also possible to be formed over the entire surface of the coupling portion 126c on the side facing the vibrator 112. The rough surface portion 126d may be formed by making the surface rough by a shot blast work, or by intentionally leaving tool marks of a milling machine (marks of the cutting work). The cross-sectional shape of the rough surface portion 126d may be a square concavo-convex shape, a triangle shape, or a sawtooth shape.

In the vibration case 126 of the third modification described above, since the rough surface portion 126d digs into the shock-absorbing members 130 when the vibrator 112 is held in-between, displacement of the shock-absorbing members 130 when the vibrator 112 vibrates may be suppressed.

### Second Embodiment

A second embodiment will be described with reference to the drawings. The same components as those of the first embodiment are designated by the same reference numerals and description thereof may be omitted or simplified.

### A. Configuration of Apparatus

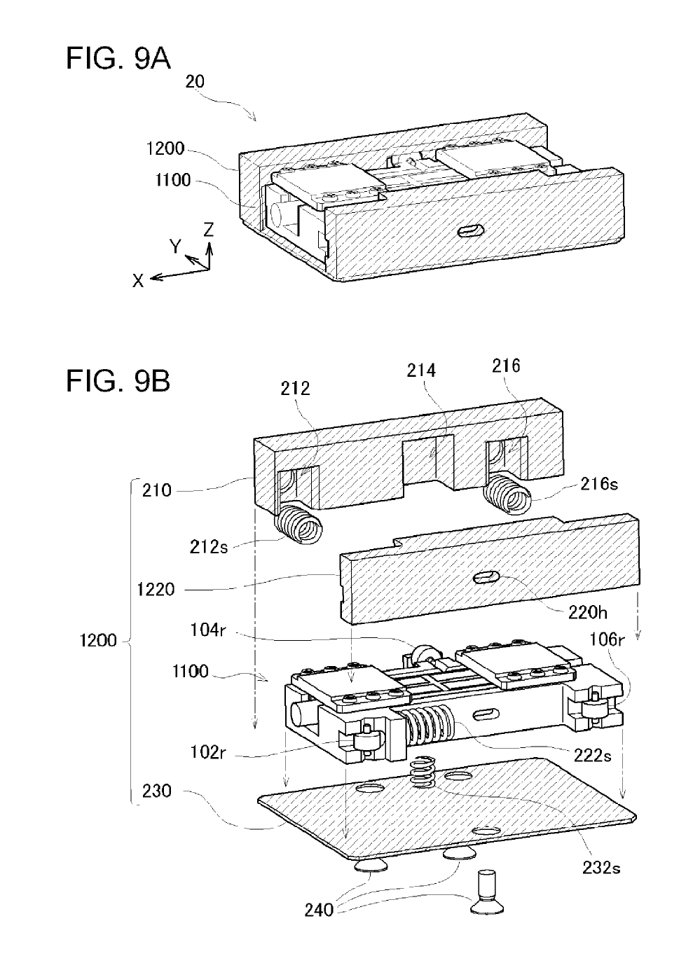

FIGS. 9A and 9B are explanatory drawings illustrating a rough configuration of a piezoelectric motor 20 of the second embodiment. FIG. 9A illustrates a general view of the piezoelectric motor 20 of the second embodiment, and FIG. 9B illustrates an exploded view.

As illustrated in FIG. 9A, the piezoelectric motor 20 of the second embodiment roughly includes a body portion 1100 and an outer case 1200. The body portion 1100 is mounted inside the outer case 1200, and in this state, is movable in one direction. In this specification, the direction of movement of the body portion 1100 is referred to as “X direction”. As illustrated in the drawings, directions orthogonal to the X direction are referred to as “Y direction” and “Z direction”, respectively.

The body portion 1100 and the outer case 1200 are each composed of a plurality of components combined each other. For example, the outer case 1200 is composed of the first side wall block 210 and a second side wall block 1220 fastened with the setscrews 240 on the both sides of the upper surface of the substantially rectangular shaped substrate 230 (see FIG. 9B). A through hole 220h is formed in the second side wall block 1220 at a substantially center in the longitudinal direction (X direction) of a side surface thereof. The role of the through hole 220h will be described later. When assembling the piezoelectric motor 20, the first side wall block 210 and the second side wall block 1220 are mounted on the substrate 230 from above the body portion 1100 by using the setscrews 240.

The first side wall block 210 is formed with the three depressions including the front housing 212, the center housing 214, and the rear housing 216. The first side wall block 210 is mounted on the substrate 230 in a state in which the front side compression spring 212s is stored in the front housing 212 and the rear side compression spring 216s is stored in the rear housing 216. Consequently, the body portion 1100 is brought into a state of being pressed against the second side wall block 1220 by the front side compression spring 212s and the rear side compression spring 216s. The front roller 102r and the rear roller 106r are mounted on a side surface of the body portion 1100 facing the second side wall block 1220. In addition, the pressure buildup spring 222s is provided on the side surface of the body portion 1100. The pressure buildup spring 222s presses the body portion 1100 in the X direction at a position on the rear side of the front roller 102r.

The holding roller 104r is provided on a side surface of the body portion 1100 on the side opposite to the side surface where the front roller 102r and the rear roller 106r are provided so as to face in the Z direction (upward in the drawing). In a state in which the first side wall block 210 is mounted, the holding roller 104r is stored in the center housing 214 of the first side wall block 210. The holding spring 232s is provided between the back side of a portion of the body portion 1100 where the holding roller 104r is provided and the substrate 230. Therefore, the holding roller 104r is in a state of being pressed against the inner surface of the center housing 214 in the Z direction (upward in the drawing).

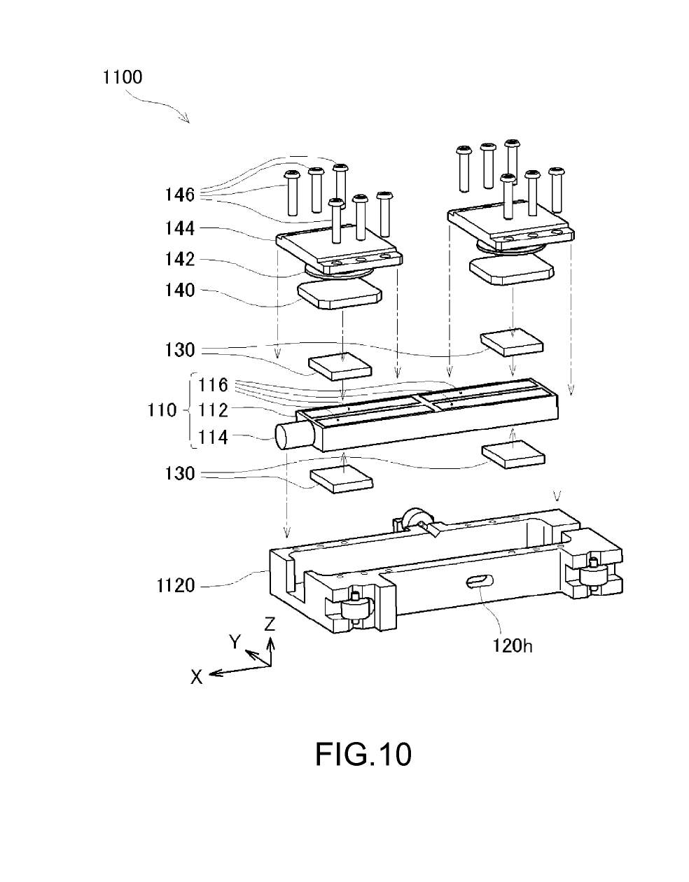

FIG. 10 is an exploded assembling drawing illustrating a structure of the body portion 1100 of the second embodiment. The body portion 1100 roughly has the structure in which the vibrating unit 110 is stored in a vibration case 1120. The vibrating unit 110 includes the vibrator 112 formed of a piezoelectric material into a parallelepiped shape, the driving projection 114 formed of ceramic and mounted on the end surface of the vibrator 112 in the longitudinal direction (X direction), and the four front electrodes 116 provided respectively on the quartering parts on one side surface of the vibrator 112. Although not illustrated in FIG. 10, a back electrode which covers almost the entire part of the side surface is provided on the side opposite to the side surface on which the four front electrodes 116 are provided, and the back electrode is grounded. A power cable, not illustrated, is drawn out from the front electrodes 116 and the back electrode as described later, and a through hole 120h for allowing the power cable to pass through is provided on a side portion of the vibration case 1120. The power cable passing through the through hole 120h is passed through the through hole 220h (see FIG. 9B) of the second side wall block 1220 and drawn out of the piezoelectric motor 20.

The vibrating unit 110 is stored in the vibration case 1120 in a state of being interposed between shock-absorbing members 130 formed of a material having a dynamic viscous resiliency (ex. a polyimide resin, rubber, elastomer) from both surfaces where the front electrodes 116 and the back electrode are provided (both surfaces in the Z direction in FIG. 10). Then, the plate-like holding plates 140, the resilient portions 142, and the holding lids 144 formed of a metallic material are placed from above the shock-absorbing members 130 on the side of the front electrodes 116, and the holding lids 144 are fastened to the vibration case 1120 with the setscrews 146. Therefore, the vibrating unit 110 is stored in a state in which the vibrator 112 may vibrate in the vibration case 1120 by a shear deformation of the resin-made shock-absorbing members 130 in spite of being held down by the resilient force of the resilient portions 142. In the second embodiment, the disc springs are used as the resilient members 142. The direction in which the shock-absorbing members 130 interpose the vibrator 112 from the both sides (Z direction) corresponds to the direction intersecting the direction of bending vibrations of the vibrator 112 (bending direction) as described later.

### B. Operation Principles of Piezoelectric Motor

The operation principles of the piezoelectric motor 20 are the same as those of the piezoelectric motor 10 shown in the first embodiment. Therefore, detailed description will be omitted.

### C. Structure of Vibration Case

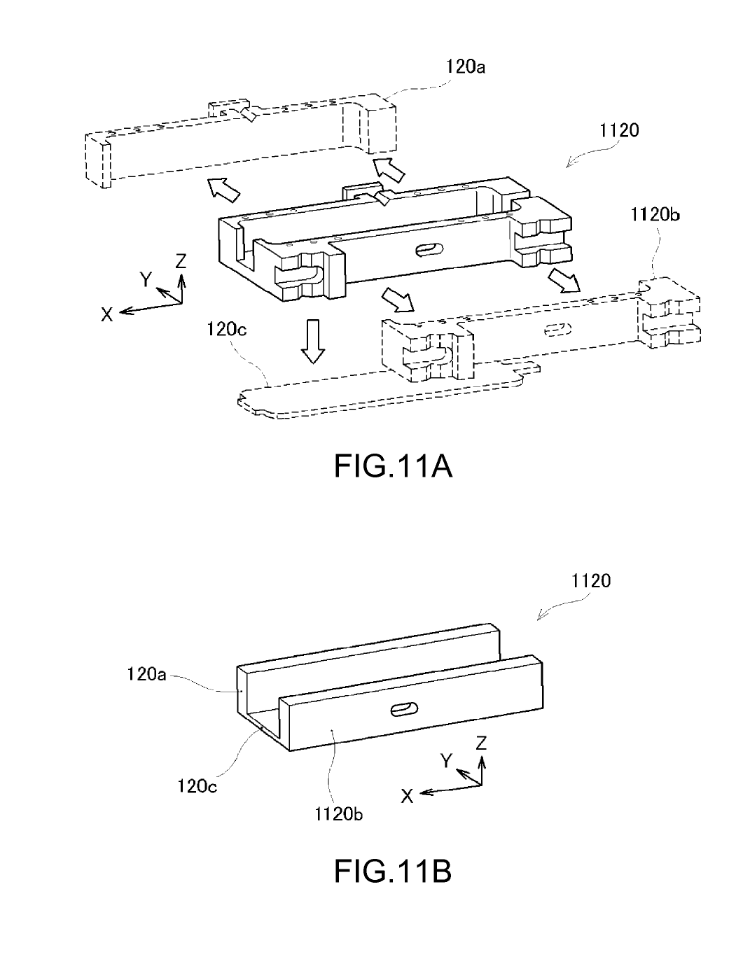

FIGS. 11A and 11B are explanatory drawings illustrating a structure of the vibration case 1120 in terms of the stiffness of the vibrator 112 in the bending direction. In terms of the stiffness in the bending direction, the vibration case 1120 of the second embodiment may be considered to have a structure in which the first side portion 120a provided in the bending direction (Y direction) with respect to the vibrator 112 (see FIG. 10) and a second side portion 1120b provided on the side opposite to the first side portion 120a with the vibrator 112 interposed therebetween are coupled by the coupling portion 120c provided in the Z direction with respect to the vibrator 112 as illustrated in FIG. 11A.

The first side portion 120a and the second side portion 1120b do not have a simple flat shape, but are provided with a structure for mounting the front roller 102r, the rear roller 106r, or the holding roller 104r (see FIG. 9B) (see FIG. 9B as regards the front roller 102r, the rear roller 106r, and the holding roller 104r). However, such a structure does not contribute to the stiffness in terms of the stiffness in the bending direction. Therefore, the structure of the vibration case 1120 of the second embodiment may be simplified as illustrated in FIG. 11B. The structure illustrated in FIG. 11B is a structure having high stiffness in the bending direction.

Since the reason why stiffness of the vibration case 1120 is high is the same as that of the vibration case 120 (see FIG. 5D) described in conjunction with the first embodiment, detailed descriptions are omitted.

As described above, the vibration case 1120 of the second embodiment has a structure in which the first side portion 120a and the second side portion 1120b are provided on the both sides of the vibrator 112 in the bending direction and the first side portion 120a and the second side portion 1120b are coupled with the coupling portion 120c from the viewpoints of securing the stiffness in the bending direction and reducing the size of the vibration case 1120. Therefore, as having been employed in the piezoelectric motor of the related art, the vibrator 112 may hardly be held with a resin member or the like from the both sides in the bending direction. Therefore, in the vibration case 1120 of the second embodiment, an innovative method such as holding the both sides of the vibrator 112 with the shock-absorbing members 130 from the thickness direction (Z direction) is employed as illustrated in FIG. 10. In other words, the structure of the vibration case 1120 of the second embodiment may be said to be a peculiar structure in that development of the innovative method of holding the vibrator 112 interposed from the thickness direction (Z direction) is required.

Here, the piezoelectric motor 20 is operated by the vibrator 112 applied with the drive voltage and deformed thereby. Therefore, the power cable for applying the drive voltage to the vibrator 112 needs to be routed. There may be a case where the power cable needs to be drawn out sideward of the piezoelectric motor 20 by layout restrictions when mounting the piezoelectric motor 20 on the respective apparatuses. Even in such a case, in order to allow the power cable to be drawn out sideward of the piezoelectric motor 20 without impairing high-stiffness features of the vibration case 1120, the second embodiment may employ a following method.

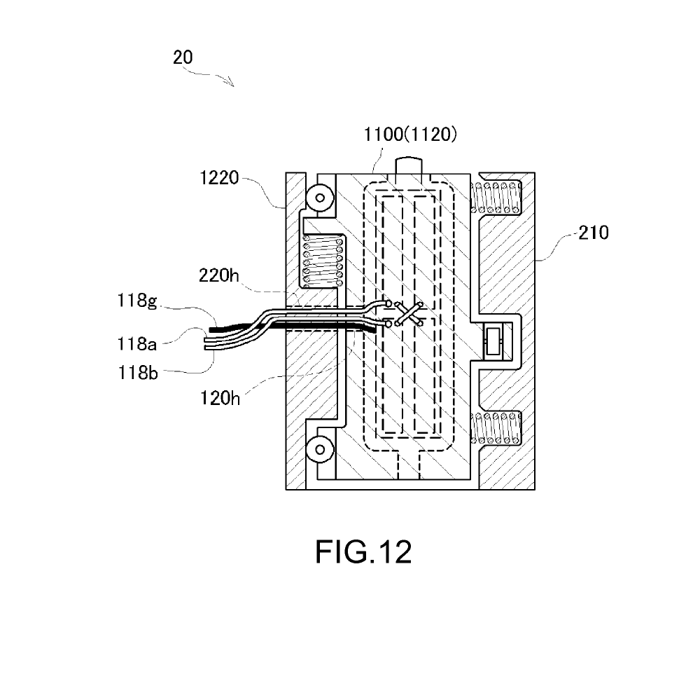

FIG. 12 is an explanatory drawing illustrating a state in which the power cable is drawn out sideward of the piezoelectric motor 20 of the second embodiment. As illustrated, the piezoelectric motor 20 of the third embodiment includes positive voltage cables 118a and 118b drawn out from the front electrodes 116 (see FIG. 10) of the vibrator 112, and a grounding cable 118g drawn out from the back electrode (not illustrated) of the vibrator 112. These power cables (the positive voltage cables 118a and 118b and the grounding cable 118g) are drawn out from the center of the vibrator 112 in the longitudinal direction where the node of vibration exists so as to minimize the influence of the vibration on the vibrator 112.

These power cables (the positive voltage cables 118a and 118b and the grounding cable 118g) are then drawn out from the side of the piezoelectric motor 20 through the through hole 120h (see FIG. 10) formed in the second side portion 1120b of the vibration case 1120 and the through hole 220h (see FIG. 9B) formed in the second side wall block 1220 of the outer case 1200. In the description of the second embodiment, the through hole 120h is formed in the second side portion 1120b. However, the through hole 120h may be formed in the first side portion 120a. In this case, the through hole 220h is also formed in the first side wall block 210 of the outer case 1200. In this manner, by drawing out the power cable from the through hole 120h formed in the second side portion 1120b (or the first side portion 120a) of the vibration case 1120, the power cable may be drawn out sideward of the piezoelectric motor 20 with little impairment of the stiffness of the vibration case 1120 from the following reasons.

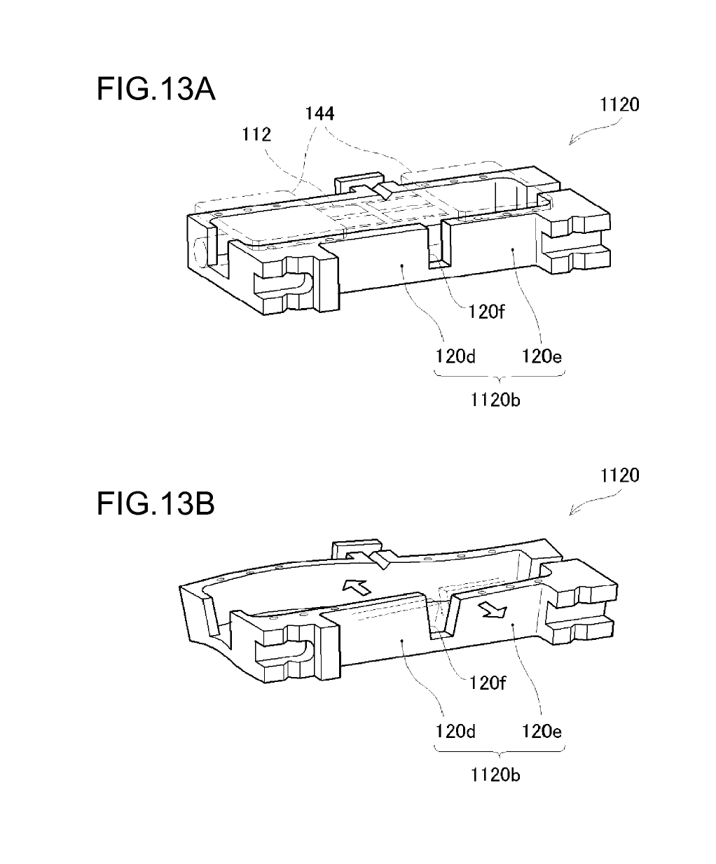

It is assumed that a notch for allowing the power cable to pass from the vibrator 112 is provided in the second side portion 1120b of the vibration case 1120. FIG. 13A illustrates the vibration case 1120 provided with a notch 120f for allowing the power cable to pass therethrough is formed in the second side portion 1120b. For the sake of convenience of understanding, in FIG. 13A, rough shapes of components other than the vibration case 1120 (for example, the vibrator 112 and the holding lid 144) are illustrated by thin broken lines. As described above, the power cable is drawn out from the substantially center of the vibrator 112 in the longitudinal direction, the notch 120f of the vibration case 1120 is also provided at the substantially center of the second side portion 1120b in the longitudinal direction.

As illustrated in FIG. 13A, when the notch 120f is provided in the second side portion 1120b of the vibration case 1120, the second side portion 1120b is roughly divided into a front part (front-side second side portion 120d) and a rear part (rear-side second side portion 120e) having substantially the same size. Consequently, as illustrated in FIG. 13B, a vibration mode in which the front-side second side portion 120d and the rear-side second side portion 120e are deformed in directions opposite to each other with the notch 120f interposed therebetween occurs, and hence the stiffness of the vibration case 1120 is significantly lowered.

In contrast, in the case where the through hole 120h is formed in the vibration case 1120 as the second embodiment, occurrence of the vibration mode (see FIG. 13B) in which the front-side second side portion 120d and the rear-side second side portion 120e are deformed in directions opposite to each other is suppressed. Therefore, the power cable may be drawn out sideward of the piezoelectric motor 20 in a state in which lowering of the stiffness of the vibration case 1120 is suppressed.

In the description given above, the through hole 120h is formed in the second side portion 1120b formed integrally. However, the second side portion 1120b may be formed by combining a plurality of members, and formed with the through hole 120h as a result of formation of the second side portion 1120b by combining a plurality of members.

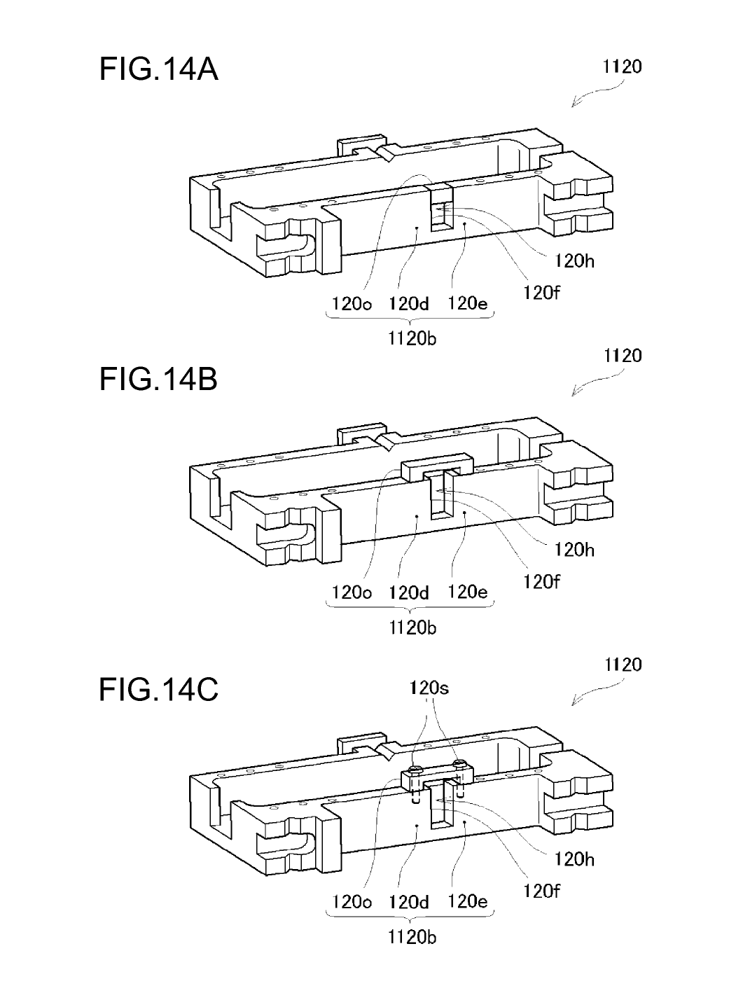

For example, in an example illustrated in FIG. 14A, a coupling member 120o is fitted into the notch 120f between the front-side second side portion 120d and the rear-side second side portion 120e from above and the coupling member 120o is coupled to the front-side second side portion 120d and the rear-side second side portion 120e by welding, blazing, or adhesion. Consequently, the second side portion 1120b is composed of the front-side second side portion 120d, the rear-side second side portion 120e, and the coupling member 120o. Accordingly, the through hole 120h is formed in a portion of the notch 120f surrounded by the front-side second side portion 120d, the rear-side second side portion 120e, and the coupling member 120o. In this manner as well, since the front-side second side portion 120d and the rear-side second side portion 120e are coupled by the coupling member 120o, occurrence of the vibration mode in which the front-side second side portion 120d and the rear-side second side portion 120e are deformed in the direction opposite to each other as illustrated in FIG. 13B may be suppressed. Therefore, lowering of the stiffness of the vibration case 1120 may be suppressed.

The coupling member 120o does not necessarily have to be fitted between the front-side second side portion 120d and the rear-side second side portion 120e, and as illustrated in FIG. 14B, the coupling member 120o may be provided above the front-side second side portion 120d and the rear-side second side portion 120e so as to be bridged over the notch 120f. In this case, although the coupling member 120o may be coupled to the front-side second side portion 120d and the rear-side second side portion 120e by welding, brazing or adhesion, fixing with screws 120s as illustrated in FIG. 14C is also applicable.

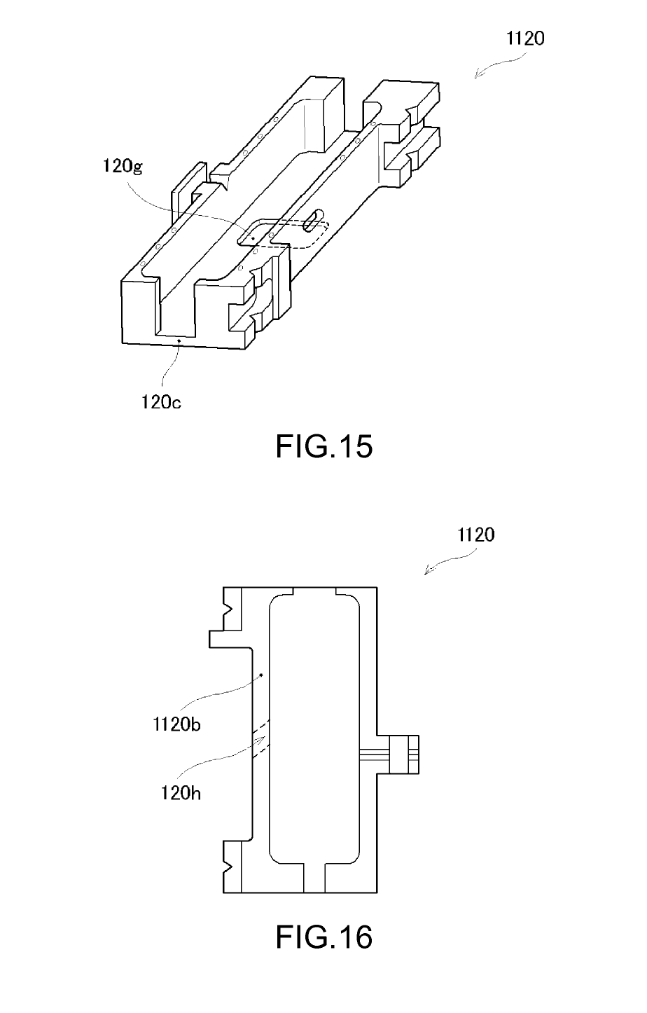

The coupling portion 120c of the vibration case 1120 may be provided with a depression (depression for cable 120g) as illustrated in FIG. 15. In this configuration, since a space for routing of the grounding cable 118g is increased, the grounding cable 118g may be routed easily. By providing the depression in the coupling portion 120c, since increase of a space between the coupling portion 120c of the vibration case 1120 and the vibrator 112 for securing the cable routing space is unnecessary, the vibration case 1120 does not need to be increased in thickness to increase the size, and hence the increase in size of the piezoelectric motor 20 is avoided.

As in the case described in the first embodiment (see FIG. 5C), when the reaction force caused by the bending vibration of the vibrator 112 acts on the vibration case 1120, the coupling portion 120c does not positively receive the load. Therefore, even though the thickness of the coupling portion 120c is partly reduced by providing the wiring depression 120g, there is little lowering in stiffness of the vibration case 1120.

The through hole 120h of the second side portion 1120b does not necessarily have to be formed vertically with respect to a side surface of the second side portion 1120b. For example, in an example illustrated in FIG. 16, the through hole 120h of the second side portion 1120b is formed so as to be inclined toward the lower left in the drawing. When the through hole 120h of the second side portion 1120b is formed so as to incline in this manner, the through hole 220h of the second side wall block 1220 of the outer case 1200 may be inclined in the same degree as the through hole 120h.

There is a case where the power cable (positive voltage cables 118a and 118b and the grounding cable 118g) needs to be drawn out obliquely from the requirement in layout when mounting the piezoelectric motor 20. In this case, the through hole 120h of the second side portion 1120b and the through hole 220h of the second side wall block 1220 are inclined in an intended direction of drawing out of the power cable, so that the power cable may be drawn out without forcedly being bent. Also, since a risk of damage of the power cable due to interference of the power cable with an angular portion of the through hole 120h or the through hole 220h may be suppressed, the cable may be protected without providing a shock-absorbing member for protecting the cable or fixing the cable by a mold process.

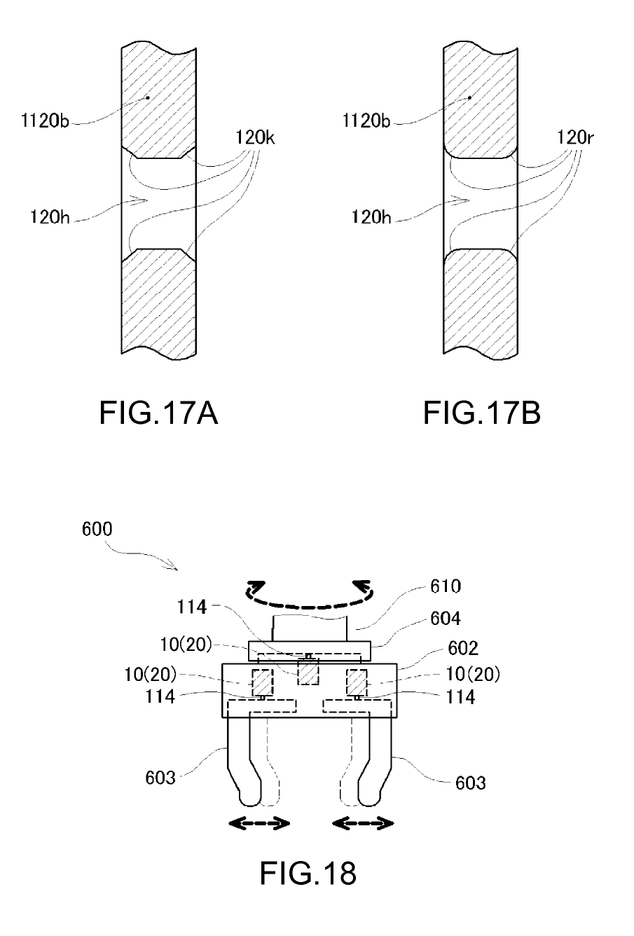

Irrespective of whether the through hole 120h penetrates vertically or obliquely with respect to the side surface of the second side portion 1120b, the angular portion may be chamfered or formed into a curved surface at a position where the through hole 120h of the second side portion 1120b is opened. FIG. 17A illustrates a case where a chamfering portion 120k is provided in the through hole 120h formed vertically with respect to the side surface of the second side portion 1120b. FIG. 17B illustrates a case where a curved surface portion 120r is provided in the through hole 120h. The angular portions at the positions where the openings of the through hole 220h are formed may also be chamfered or formed into a curved surface also in the second side wall block 1220 of the outer case 1200. In this configuration, even though the power cable (the positive voltage cables 118a and 118b and the grounding cable 118g) vibrates and is grazed against the portion where the through hole 120h is opened, or when the power cable is pressed against the portion where the through hole 120h is opened by the tensile force thereof, a risk of damage or disconnection of the power cable may be suppressed.

### Applications

The piezoelectric motor 10 (20) of the embodiments described above may be assembled desirably in the apparatus as described below.

FIG. 18 is an explanatory drawing illustrating a robot hand 600 in which the piezoelectric motor 10 (20) of the first embodiment or the second embodiment is assembled. The illustrated robot hand 600 includes a plurality of finger portions 603 extending upright from a base 602, and is connected to an arm 610 via a wrist 604. Here, base portions of the finger portions 603 are movable within the base 602, and the piezoelectric motors 10 (20) is mounted in a state in which the driving projection 114 is pressed against the base portions of the finger portions 603. Therefore, by operating the piezoelectric motors 10 (20), the finger portions 603 may be moved to grip an object. The portion of the wrist 604 is provided with the piezoelectric motor 10 (20) in a state in which the driving projection 114 is pressed against an end surface of the wrist 604. Therefore, by operating the piezoelectric motor 10 (20), the entire part of the base 602 may be rotated.

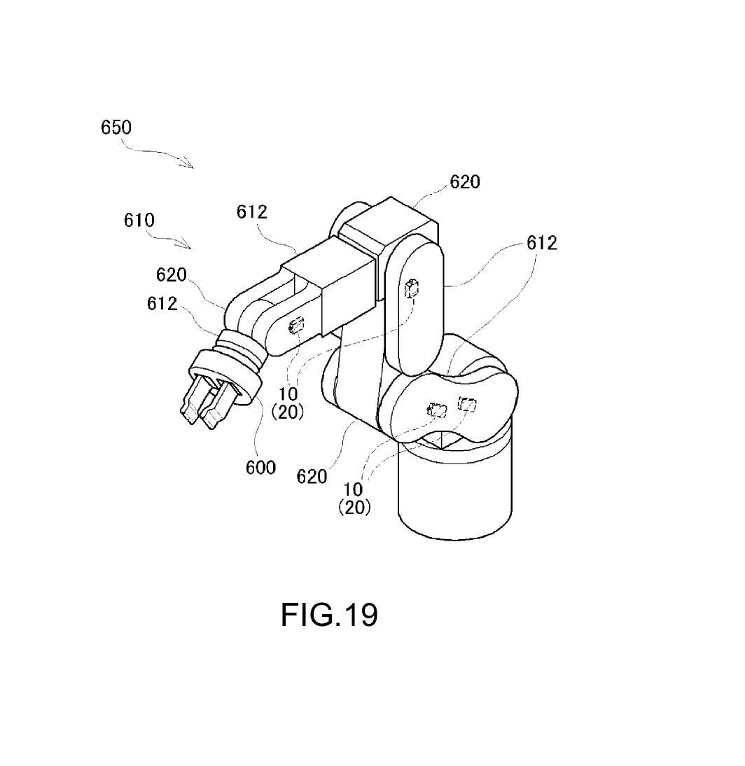

FIG. 19 is an explanatory drawing illustrating a single arm robot 650 having the robot hand 600 (hand portion). As illustrated, the robot 650 includes a plurality of link portions 612 (link members) and the arm 610 (arm portion) having joint portions 620 connecting the link portions 612 so as to allow bending thereof. The robot hand 600 is connected to the distal end of the arm 610. The joint portions 620 each include the piezoelectric motor 10 (20). Therefore, by operating the piezoelectric motor 10 (20), the respective joint portions 620 may be bent to given angles.

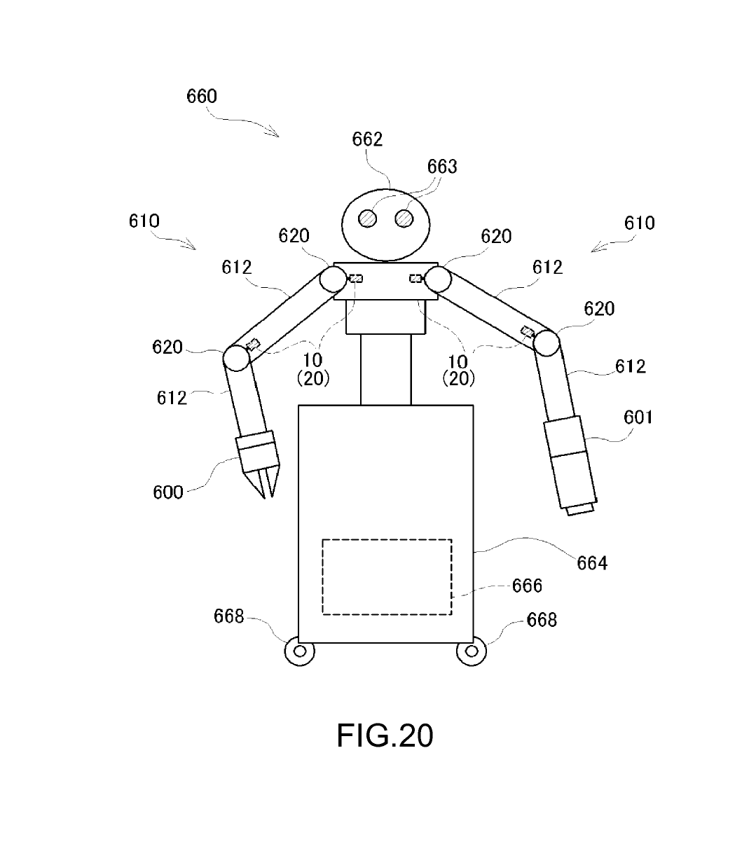

FIG. 20 is an explanatory drawing illustrating a plural arm robot 660 having the robot hand 600. As illustrated, the robot 650 includes the plurality of link portions 612 and a plurality (two in the illustrated example) of the arms 610 having the joint portions 620 connecting the link portions 612 so as to allow bending thereof. The robot hands 600 and a tool 601 (hand portion) are connected to the distal end of the arm 610. A plurality of cameras 663 are mounted on a head portion 662, and a control portion 666 configured to control the entire operation is mounted in the interior of a body portion 664. In addition, the robot 660 is configured to allow a transfer using casters 668 provided on a bottom surface of the body portion 664. In this robot 660 as well, the joint portions 620 each include the piezoelectric motor 10 (20) integrated therein. Therefore, by operating the piezoelectric motor 10 (20), the respective joint portions 620 may be bent to given angles.

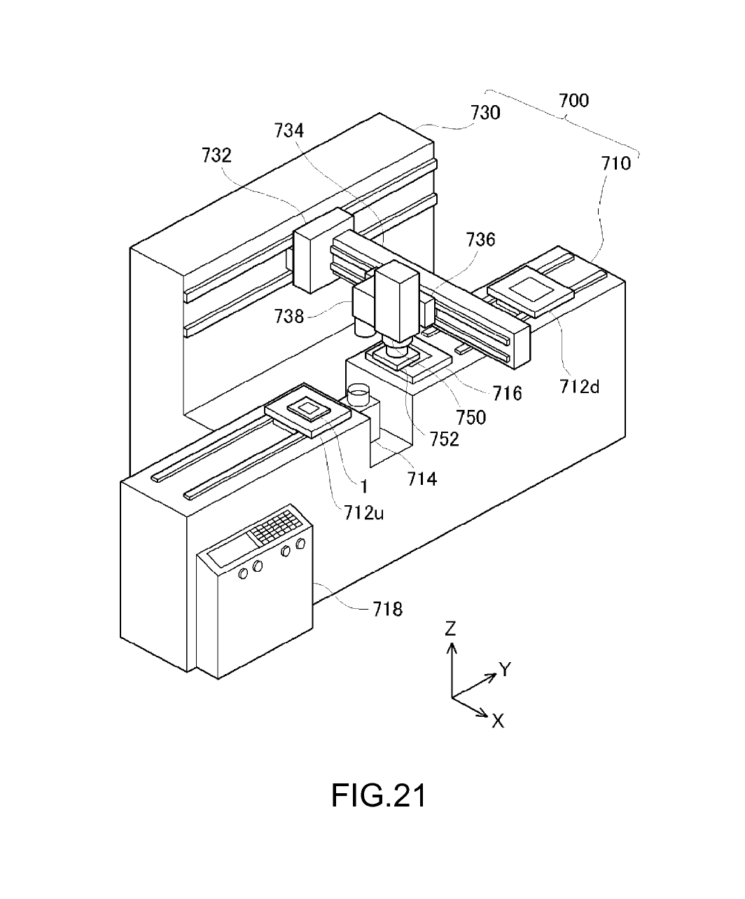

FIG. 21 is a perspective view illustrating an electronic component inspecting apparatus 700 in which the piezoelectric motor 10 (20) of the first embodiment or the second embodiment is assembled. The illustrated electronic component inspecting apparatus 700 roughly includes abase 710, and a supporting base 730 projecting upright on a side surface of the base 710. An upper surface of the base 710 includes an upstream side stage 712u on which an electronic component 1 to be inspected is placed and carried, and a downstream side stage 712d on which the electronic component 1 after the inspection is placed and carried are provided. An image pickup apparatus 714 for confirming the posture of the electronic component 1 and an inspection table 716 (inspecting portion) on which the electronic component 1 is set for inspecting the electric feature are provided between the upstream side stage 712u and the downstream side stage 712d. Examples of representatives of the electronic component 1 include “semiconductors”, “semiconductor wafers”, “display devices such as CLD or OLED”, “crystal devices”, “various sensors”, “ink jet heads”, and “various MEMS devices”.

The supporting base 730 is provided with a Y-stage 732 so as to be movable in the direction (Y direction) parallel to the upstream side stage 712u and the downstream side stage 712d of the base 710, and an arm portion 734 is extended from the Y-stage 732 in the direction (X direction) toward the base 710. A side surface of the arm portion 734 is provided with an X-stage 736 so as to be movable in the X direction. Then, the X-stage 736 is provided with an image pickup camera 738 and the gripping device 750 including a Z stage movable in the vertical direction (Z direction) integrated therein. A grip portion 752 configured to grip the electronic component 1 is provided at a distal end of the gripping device 750. The grip portion 752 is driven by the piezoelectric motor 10 (20) (not illustrated) and grips the electronic component 1. In addition, a control device 718 configured to control the operation of the entire electronic component inspecting apparatus 700 is provided on a front surface of the base 710. In the third embodiment, the Y-stage 732, the arm portion 734, the X-stage 736, and the gripping device 750 provided on the supporting base 730 correspond to the “electronic compartment transporting apparatus” according to the invention.

The electronic component inspecting apparatus 700 configured as described above performs an inspection of the electronic component 1 in the following manner. First of all, the electronic component 1 to be inspected is placed on the upstream side stage 712u and moves to the vicinity of the inspection table 716. Subsequently, the Y-stage 732 and the X-stage 736 are moved to move the gripping device 750 to a position right above the electronic component 1 placed on the upstream side stage 712u. At this time, the position of the electronic component 1 may be confirmed by using the image pickup camera 738. Then, when the gripping device 750 is moved downward by using the Z stage integrated in the gripping device 750, and the electronic component 1 is gripped by the grip portion 752, the gripping device 750 is moved onto the image pickup apparatus 714, and the posture of the electronic component 1 is confirmed by using the image pickup apparatus 714. Subsequently, the posture of the electronic component 1 is adjusted by using a fine-adjustment mechanism integrated in the gripping device 750. Then, after the gripping device 750 is moved to a portion on the inspection table 716, the Z stage integrated in the gripping device 750 is moved to set the electronic component 1 on the inspection table 716. Since the posture of the electronic component 1 is adjusted by using the fine-adjustment mechanism in the gripping device 750, the electronic component 1 may be set to a right position onto the inspection table 716. Then, when the inspection of the electric feature of the electronic component 1 is terminated by using the inspection table 716, the electronic component 1 is taken out from the inspection table 716 again, and then the Y-stage 732 and the X-stage 736 are moved to move the gripping device 750 onto the downstream side stage 712d, whereby the electronic component 1 is placed on the downstream side stage 712d. Then, the downstream side stage 712d is moved and the electronic component 1 after the inspection is transported to a predetermined position.

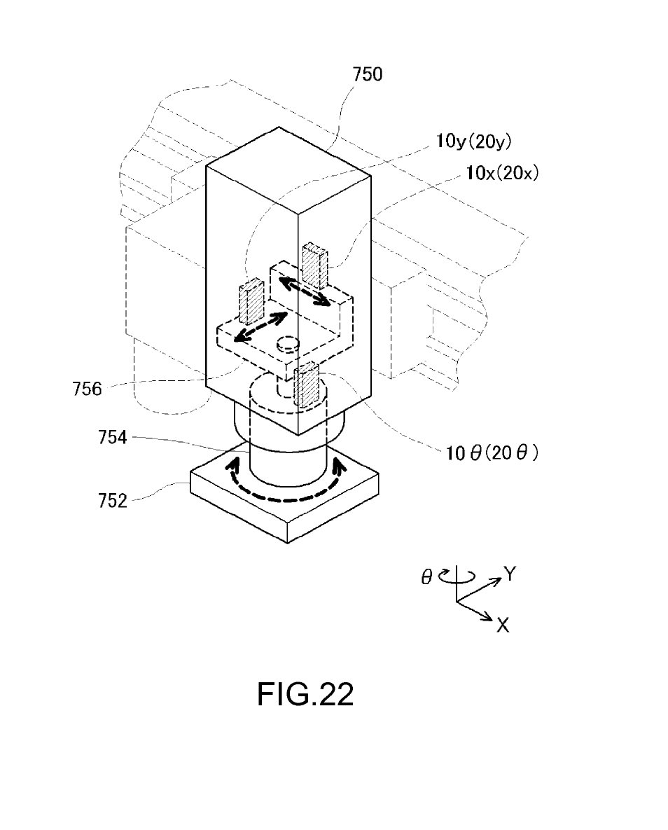

FIG. 22 is an explanatory drawing about the fine-adjustment mechanism integrated in the gripping device 750. As illustrated, a rotating shaft 754 connected to the grip portion 752 and a fine-adjustment plate 756 to which the rotating shaft 754 is rotatably mounted are provided in the gripping device 750. The fine-adjustment plate 756 is movable in the X direction and the Y direction by being guided by a guiding mechanism, not illustrated.

Here, as illustrated with hatch in FIG. 22, a piezoelectric motor 10θ (20θ) for the direction of rotation is mounted so as to face an end surface of the rotating shaft 754, and a driving projection (not illustrated) of the piezoelectric motor 10θ (20θ) is pressed against the end surface of the rotating shaft 754. Therefore, by operating the piezoelectric motor 10θ (20θ), the rotating shaft 754 (and the grip portion 752) may be rotated by a given angle in a θ direction with high degree of accuracy. Also, a piezoelectric motor 10x (20x) for the X direction and a piezoelectric motor 10y (20y) for the Y direction are provided so as to face the fine-adjustment plate 756, and respective driving projections (not illustrated) are pressed against the surface of the fine-adjustment plate 756. Therefore, by operating the piezoelectric motor 10x (20x), the fine-adjustment plate 756 (and the grip portion 752) may be moved by a given distance in the X direction with high degree of accuracy and, in the same manner, by moving the piezoelectric motor 10y (20y), the fine-adjustment plate 756 (and the grip portion 752) may be moved in the Y direction by a given distance with high degree of accuracy. Therefore, the electronic component inspecting apparatus 700 in FIG. 21 is capable of fine-adjusting the posture of the electronic component 1 gripped by the grip portion 752 by operating the piezoelectric motor 10θ (20θ), the piezoelectric motor 10x (20x), and the piezoelectric motor 10y (20y).

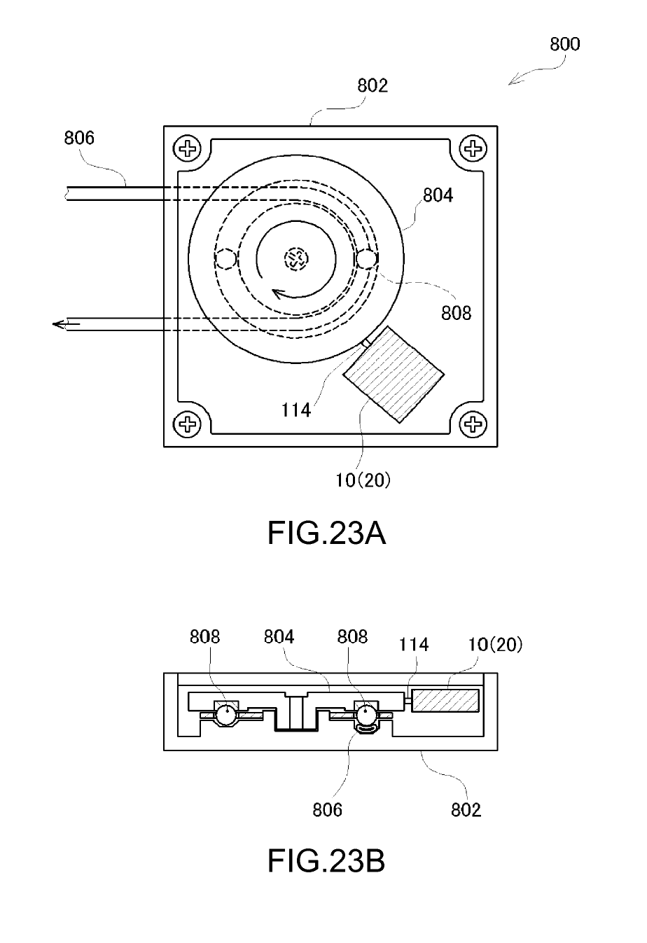

FIGS. 23A and 23B are explanatory drawings illustrating a liquid feeding pump 800 in which the piezoelectric motor 10 (20) of the first embodiment or the second embodiment is assembled. FIG. 23A illustrates a plan view of the liquid feeding pump 800 viewed from the top, and FIG. 23B illustrates a cross-sectional view of the liquid feeding pump 800 viewed from the side. In the liquid feeding pump 800 as illustrated in the drawing, a disk-shaped rotor 804 (moving portion) is rotatably provided in a square shaped case 802, and a tube 806 (liquid tube) through which liquid such as drug solution flows is placed between the case 802 and the rotor 804. Parts of the tube 806 are collapsed and closed by balls 808 (closed portions) provided in the rotor 804. Therefore, when the rotor 804 rotates, the positions where the balls 808 collapse the tube 806 are moved, and hence the liquid in the tube 806 is fed. If the driving projection 114 of the piezoelectric motor 10 (20) is provided in a state of pressing the driving projection 114 against a side surface of the rotor 804, the rotor 804 may be driven. Accordingly, the liquid feeding pump 800 capable of feeding a very small amount of liquid with high degree of accuracy and in addition which has a compact size may be realized.

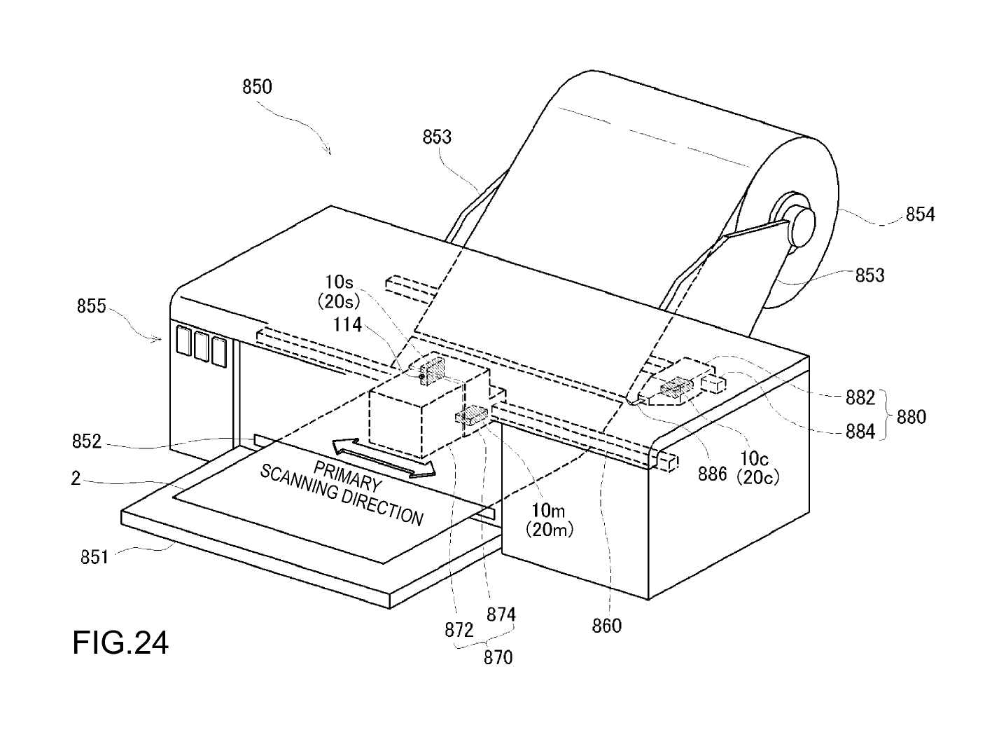

FIG. 24 is a perspective view illustrating a printing apparatus 850 in which the piezoelectric motor 10 (20) of the first embodiment or the second embodiment is assembled. The illustrated printing apparatus 850 is a so-called ink jet printer configured to eject ink onto a surface of a printing medium 2 to print an image. The printing apparatus 850 has a substantially box shape in appearance, and includes a paper discharge tray 851, a discharge port 852, and a plurality of operating buttons 855 provided at a substantially center of a front surface thereof. A paper holder 853 on which the rolled printing medium 2 (a roll paper 854) is set is provided on the back side thereof. When the roll paper 854 is set on the paper holder 853 and the operating button 855 is operated, the roll paper 854 set on the paper holder 853 is fed in and an image is printed on the surface of the printing medium 2 in the interior of the printing apparatus 850. The roll paper 854 is discharged from the discharge port 852 after having cut by a cutting mechanism 880, described later, mounted in the interior of the printing apparatus 850.

A print head 870 reciprocating in a primary scanning direction on the printing medium 2 and a guide rail 860 guiding the movement of the print head 870 in the primary scanning direction are provided in the interior of the printing apparatus 850. The illustrated print head 870 includes a printing portion 872 configured to eject ink on the printing medium 2, and a scanning portion 874 for scanning in the primary scanning direction. A plurality of ejection nozzles are provided on the bottom surface side (on the side facing the printing medium 2) of the printing portion 872 and ink may be ejected from the ejection nozzle toward the printing medium 2. A piezoelectric motor 10m (20m) and 10s(20S) are mounted on the scanning portion 874. A driving projection (not illustrated) of the piezoelectric motor 10m (20m) is pressed against the guide rail 860. Therefore, by operating the piezoelectric motor 10m (20m), the print head 870 may be moved in the primary scanning direction. Also, the driving projection 114 of the piezoelectric motor 10s (20s) is pressed against the printing portion 872. Therefore, by operating the piezoelectric motor 10s (20s), the bottom side of the printing portion 872 may be moved toward the printing medium 2 or may be moved away from the printing medium 2. Also, the cutting mechanism 880 for cutting the roll paper 854 is mounted on the printing apparatus 850. The cutting mechanism 880 includes a cutter holder 884 including a paper cutter 886 mounted at a distal end thereof and a guide shaft 882 extending through the cutter holder 884 in the primary scanning direction. A piezoelectric motor 10c (20c) is mounted in the cutter holder 884, and a driving projection, not illustrated, of the piezoelectric motor 10c (20c) is pressed against the guide shaft 882. Therefore, when the piezoelectric motor 10c (20c) is operated, the cutter holder 884 moves in the primary scanning direction along the guide shaft 882, and the paper cutter 886 cuts the roll paper 854. It is also possible to use the piezoelectric motor 10 (20) for feeding the printing medium 2.

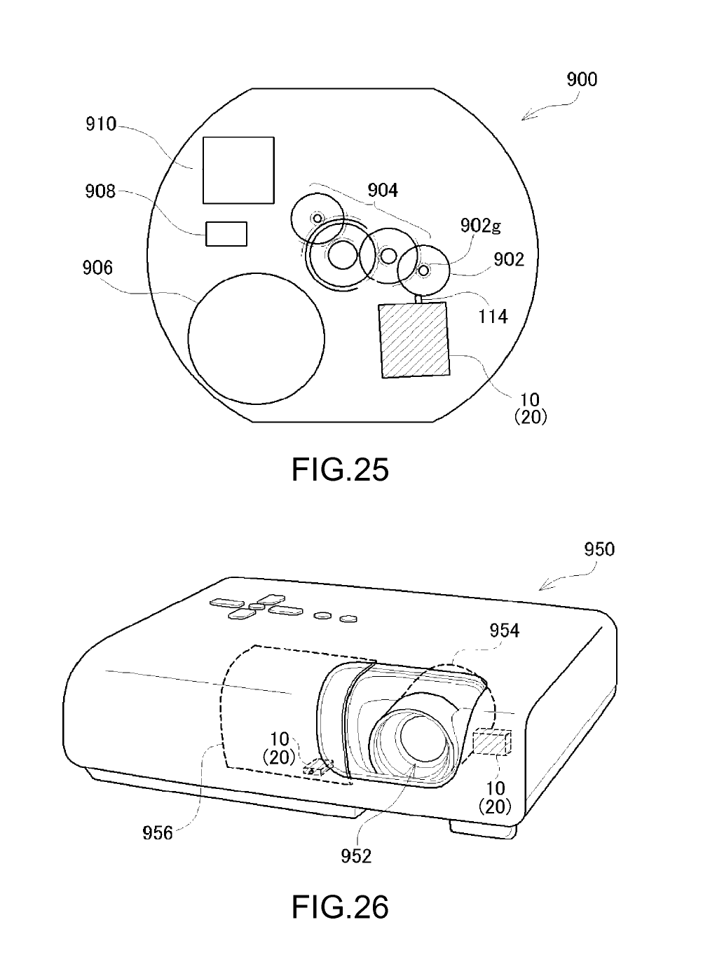

FIG. 25 is an explanatory drawing illustrating an interior structure of an electronic timepiece 900 in which the piezoelectric motor 10 (20) of the first embodiment or the second embodiment is assembled. FIG. 25 illustrates a plan view viewed from the side (back lid side) opposite to the time-of-day display side of the electronic timepiece 900. The electronic timepiece 900 illustrated in FIG. 25 includes a disc-shaped rotating disk 902, a gear train 904 configured to transmit the rotation of the rotating disk 902 to hands which indicate the time of day (not illustrated), the piezoelectric motor 10 (20) for driving the rotating disk 902, an power supply unit 906, a crystal chip 908, and an IC 910 in the interior thereof. Also, the power supply unit 906, the crystal chip 908, and the IC 910 are mounted on a circuit board, not illustrated. The gear train 904 includes a plurality of gears and a ratchet, not illustrated. In order to avoid complication of the illustration, lines connecting tooth tips of the gears are indicated by thin chain lines, and lines connecting tooth roots of the gears are indicated by thick solid lines. Therefore, a double circle including the thick solid line and the thin chain line indicate the gear. The thin chain lines indicating the tooth tips are not illustrated entirely around the circumferences thereof, and are illustrated only partly along the portions engaging other gears.

The rotating disk 902 is provided coaxially with a smaller gear 902g and the gear 902g engages the gear train 904. Therefore, the rotation of the rotating disk 902 is transmitted along the gear train 904 while being reduced in speed at a predetermined ratio. Then, the rotations of these gears are transmitted to the hands which indicate the time of day, and display the time of day. If the driving projection 114 of the piezoelectric motor 10 (20) of the above-described embodiment is provided in a state of pressing the driving projection 114 against a side surface of the rotating disk 902, the rotating disk 902 may be rotated.

FIG. 26 is an explanatory drawing illustrating a projecting apparatus 950 in which the piezoelectric motor 10 (20) of the first embodiment or the second embodiment is assembled. As illustrated, the projecting apparatus 950 is provided with a projecting unit 952 including an optical lens, and an image is displayed by projecting light from a light source (not illustrated) integrated therein. Then, an adjusting mechanism 954 (adjusting portion) for focusing the optical lens included in the projecting unit 952 may be driven by using the piezoelectric motor 10 (20) of the embodiments described above. Since the piezoelectric motor 10 (20) has a high resolution performance of positioning, delicate focusing may be preformed. While the light from the light source is not projected, the optical lens of the projecting unit 952 is covered with a lens cover 956, whereby the optical lens may be prevented from being subjected to scratches. In order to open and close the lens cover 956, the piezoelectric motor 10 (20) of the above-described embodiment may be used.

Although the piezoelectric motor of the embodiments, the modifications, and the applications of the various apparatuses on which the piezoelectric motor have been described thus far, the invention is not limited to the embodiments, the modifications, and the applications described above, and various modes may be employed without departing the scope of the invention.

The entire disclosure of Japanese Patent Application No. 2012-204043 filed Sep. 18, 2012 and No. 2012-204044 filed Sep. 18, 2012 are expressly incorporated by reference herein.

What is claimed is:

1. A piezoelectric motor comprising a vibrator of a piezoelectric material, and configured to vibrate in a stretching direction and a bending direction by an application of a voltage; and
a vibration case in which the vibrator is accommodated,
the vibration case includes:
a first side portion provided in the bending direction with respect to the vibrator;
a second side portion provided on the side opposite to the first side portion with the vibrator interposed therebetween; and
a coupling portion provided in a direction orthogonal to the bending direction and the stretching direction with respect to the vibrator, and configured to couple the first side portion and the second side portion.

2. The piezoelectric motor according to claim 1, wherein
the length of the first side portion in the stretching direction, the length of the second side portion in the stretching direction, and the length of the coupling portion in the stretching direction are formed to be longer than the length of the vibrator in the stretching direction.

3. The piezoelectric motor according to claim 1, wherein
the first side portion, the second side portion, and the coupling portion each have a plate-like portion, and
the thickness of the plate-like portion that the coupling portion has is thinner than the thickness of the plate-like portion that the first side portion has and the thickness of the plate-like portion that the second side portion has.

4. The piezoelectric motor according to claim 1, wherein
the coupling portion is provided with a projection on the side facing the vibrator, the projection being configured to support the vibrator at a position corresponding to a node of vibration in the bending direction.

5. The piezoelectric motor according to claim 4, wherein
the coupling portion is provided with a depression on the side facing the vibrator, at a position corresponding to the node of vibration in the bending direction, and
the vibrator is supported by a shock-absorbing member provided in the depression.

6. The piezoelectric motor according to claim 4, wherein
the coupling portion is provided with the shock-absorbing member configured to support the vibrator on the side facing the vibrator at a position corresponding to the node of vibration in the bending direction, and at least a portion where the shock-absorbing member is provided is formed into a concavo-convex shape.

7. A piezoelectric motor comprising a vibrator of a piezoelectric material, and configured to vibrate in a stretching direction and a bending direction by an application of a voltage; and
a vibration case in which the vibrator is accommodated,
the vibration case includes:
a first side portion provided in the bending direction with respect to the vibrator;
a second side portion provided on the side opposite to the first side portion with the vibrator interposed therebetween; and
a coupling portion provided in a direction orthogonal to the bending direction and the stretching direction with respect to the vibrator and configured to couple the first side portion and the second side portion, wherein
the first side portion or the second side portion is provided with a through hole.

8. The piezoelectric motor according to claim 7, wherein
the through hole is provided at a position corresponding to the node of vibration when the vibrator vibrates in the bending direction.

9. The piezoelectric motor according to claim 7, wherein
the through hole is provided obliquely with respect to the bending direction of the vibrator.

10. The piezoelectric motor according to claim 7, wherein
the first side portion or the second side portion provided with the through hole is composed of a plurality of members, and
the through hole is provided between the plurality of members.

11. The piezoelectric motor according to claim 7, wherein
the coupling portion is provided with a depression on the side facing the vibrator at a position corresponding to the through hole.

12. The piezoelectric motor according to claim 7, wherein
the first side portion or the second portion is provided with a chamfered portion or a curved surface portion at an angular portion of a position where the through hole is formed.

13. A robot hand including a plurality of finger portions and configured to grip an object, comprising
a base body on which the finger portions are provided upright so as to be movable; and
the piezoelectric motor according to claim 1 configured to move the finger portions with respect to the base body.

14. A robot comprising:
an arm portion provided with a rotatable joint portion;
a hand portion provided with the arm portion; and
a main body portion provided with the arm portion, and the piezoelectric motor according to claim 1 provided on the joint portion and configured to bend or rotate the joint portion.

15. The robot according to claim 14, wherein
the through hole is provided at a position corresponding to a node of vibration when the vibrator vibrates in the bending direction.

16. The robot according to claim 14, wherein
the through hole is provided obliquely with respect to the bending direction of the vibrator.

17. An electronic component transporting apparatus comprising:
a grip portion configured to grip an electronic component; and
the piezoelectric motor according to claim 1 configured to drive the grip portion gripping the electronic component.

18. An electronic component inspecting apparatus comprising:
a grip portion configured to grip an electronic component;
piezoelectric motor according to claim 1 configured to drive the grip portion gripping the electronic component; and
an inspection unit configured to inspect the electronic component.

19. A liquid feeding pump comprising:
a liquid tube in which liquid can flow;
a closing portion configured to close the liquid tube by coming into abutment with part of the liquid tube;
a moving portion configured to move the closed portion of the liquid tube by moving in the state of holding the closing portion; and
the piezoelectric motor according to claim 1 configured to move the moving portion.

20. A printing apparatus comprising:
a print head configured to print an image on a medium; and
the piezoelectric motor according to claim 1 configured to move the print head.
